(19) United States
(12) Patent Application Publication
(10) Pub. No.: US 2016/0357173 A1
(43) Pub. Date: Dec. 8, 2016

(54) Evidence Generation and Data Interpretation Platform

(71) Applicant: Evidation Health, Menlo Park, CA (US)

(72) Inventors: Luca Foschini, Santa Barbara, CA (US); Alessio Signorini, Santa Barbara, CA (US); Tom Quisel, Santa Barbara, CA (US); Christine Lemke, San Francisco, CA (US); Ursula Nasch, Lakeland, FL (US)

(21) Appl. No.: 14/733,455

(22) Filed: Jun. 8, 2015

(51) Int. Cl. G05B 19/406

(52) U.S. Cl. CPC G05B 19/406; G05B 2219/32367

(57) ABSTRACT

In one implementation, a computer-implemented method includes receiving a request to perform an experiment across a plurality of client computing devices associated with a plurality of users, the request includes criteria for users to be included in the experiment and parameters for the experiment; obtaining information for the plurality of users; selecting a subset of the plurality of users for the experiment based, at least in part, on the information; determining a minimum population size to provide at least a threshold (i) level of anonymity for participants in the experiment and (ii) power calculation for results of the experiment, wherein the minimum population size is determined based, at least in part, on the subset of the plurality of users and the parameters for the experiment; providing information that identifies the minimum population size for the experiment.

### TECHNICAL FIELD

This document generally describes technology related to computer-based evidence generating systems, and for improving the operation of such computer-based systems.

### BACKGROUND

Researchers have designed and performed experiments to determine whether and to what extent something (e.g., stimuli, absence of stimuli) will affect the behavior of a subject, such as a user of a computing device. For example, researchers have performed experiments into whether particular types of messaging, such as emails, text messages, and push-based notifications are effective to encourage or dissuade particular types of behavior in users, such as smoking, exercise and self-tracking of health and wellness metrics.

Experiments have been designed with different arms that separate users into different groups and subject the users to different types of stimuli. The results from the arms of an experiment can be compared to determine the effectiveness and/or ineffectiveness of particular stimuli. For instance, an experiment can include control arms that establish neutral baselines for user behavior, and treatment arms that expose users to different treatment methodologies (example stimuli). Results within each of the arms of an experiment can be aggregated and compared to determine whether and to what extent the treatment methodologies that were tested had a positive or negative effect on user behavior.

### SUMMARY

This document generally describes computer-based technology for evidence generating and data interpretation platforms through which users (e.g., researchers) are able to design and execute experiments (e.g., behavioral experimentation, trials, tests, studies) that will be performed across a distributed network of client computing devices (e.g., mobile computing devices, wearable devices, desktop computers, and laptops). Such platforms can include both client-side and server-side computing devices that are programmed to interact in particular ways to provide a platform that can be used by researchers in a variety of flexible manners. Examples of such platforms that are described throughout this document are experimentation platforms through which researchers can design and perform experiments across populations of users. Other types and uses of platforms are also possible, and features that are described with regard to example experimentation platforms can also be implemented with such other types and uses of platforms.

For example, a computer system (e.g., server system, cloud-based computer system) can be programmed to receive parameters for an experiment from a researcher, to identify appropriate users to include in the experiment based on the parameters, to push the experiment out to computing devices for the identified users, to aggregate results from the computing devices that are participating in the experiment, and to provide the results of the experiment to the researcher in a way that will preserve the anonymity of the users who participated in the experiment. Client computing devices in such an example can be programmed (e.g., run a particular application, such as a mobile app and/or web application) to use information from the computer system to implement the experiment (e.g., output particular stimuli to users at particular times and in particular ways), to detect users' responses to the experiment (e.g., detect behavioral changes), and to provide the results back to the computer system. Such a platform may be operated by a first organization and employed by researchers from other organizations that are separate from the first organization, and may expose certain data to the researchers while obscuring or otherwise blocking access to such data (e.g., data that might be used to infer user identities).

In one implementation, a computer-implemented method includes receiving, at a computer system and from an experiment designer computing device, a request to perform an experiment across a plurality of client computing devices that are associated with a plurality of users, wherein the request includes (i) criteria for users to be included in the experiment and (ii) parameters for the experiment; obtaining, by the computer system, information for the plurality of users that indicates whether the plurality of users satisfy the criteria for the experiment; selecting, by the computer system, a subset of the plurality of users for the experiment based, at least in part, on the information; determining, by the computer system, a minimum population size to provide at least a threshold (i) level of anonymity for participants in the experiment and (ii) power calculation for results of the experiment, wherein the minimum population size is determined based, at least in part, on the subset of the plurality of users and the parameters for the experiment; providing, by the computer system and to the experiment designer computing device, information that identifies the minimum population size for the experiment.

Such a computer-implemented method can optionally include one or more of the following features. Obtaining the information for the plurality of users can include providing, by the computer system, the criteria to the plurality of client computing devices, wherein the plurality of client computing devices are each programmed to evaluate the criteria locally and to determine whether a user that corresponds to a particular client device satisfies the criteria for the experiment; and receiving, at the computer system, responses from the plurality of client computing devices that indicate whether their corresponding users satisfy the criteria, wherein the information for the plurality of users includes the responses from the plurality of client computing devices. The responses from the plurality of client computing devices can be received without receiving underlying data that describes aspects of a user that the client computing devices uses to evaluate the criteria for the experiment.

Obtaining the information for the plurality of users can include accessing, by the computer system, current data for the plurality of users and for the plurality of client computing devices from one or more data sources; and determining, by the computer system, whether the plurality of users satisfy the criteria based on a comparison of the data with the criteria. The criteria can include one or more of the following: access to health monitoring devices, current use of the health monitoring devices, current health behavior, current or past communication and social behavior, one or more current medical conditions, a current health context, message and notifications settings on the plurality of client computing devices, and current involvement in other experiments. The subset of the plurality of users that are selected can include users who are determined to satisfy the criteria for the experiment.

The parameters for the experiment can include one or more of the following: a desired statistical power to detect an effect of a particular size, a number of arms to be used for the experiment, and a hypothesis to be tested with the experiment. The hypothesis to be tested can include one or more of: a threshold change in health behavior along one or more dimensions for users within a treatment arm for the experiment and a threshold change in one or more medical conditions along one or more dimensions for users within the treatment arm for the experiment. The threshold level of anonymity can include k-anonymity for users included the experiment based on the parameters for the experiment and a number of data fields across which results for the experiment will be provided to the experiment designer computing device.

The computer-implemented method can further include determining, by the computer system, whether the subset of the plurality of users satisfies the minimum population size; and determining, in response to determining that the subset of the plurality of users is less than the minimum population size, that the experiment is unable to be performed as designed. The information that is provided to the experiment designer computing device can additionally indicate that the experiment is unable to be performed as designed.

The computer-implemented method can further include receiving, at the computer system and after providing the minimum population size, information that designates a sample size for the experiment; selecting, by the computer system and based on the sample size, participants for the experiment from among the subset of the plurality of users, wherein the participants are associated with a subset of the client computing devices; and providing, by the computer system and to the subset of the client computing devices, one or more sets of rules to be followed by the subset of the client computing devices to implement the experiment. The computer-implemented method can further include assigning, by the computer system, the participants into a plurality of arms for the experiment, wherein each of the plurality of arms uses a different one of the sets of rules to implement the experiment. The computer-implemented method can further include receiving, at the computer system and from the subset of client computing devices, results from the experiment; aggregating, by the computer system, the results so that information about the participants is anonymous; and providing, to the experiment designer computing device, the aggregated results.

In another implementation, a computer-implemented method includes receiving, at a computer system, parameters for an experiment to be performed across a plurality of client computing devices that are associated with a plurality of users, wherein the parameters identify a plurality of arms for the experiment that will each be exposed to different stimuli as part of the experiment; determining, by the computer system and based on the parameters, a plurality of rule sets to be used by the plurality of client computing devices to implement the plurality of arms of the experiment; generating, by the computer system, assignment information to be used by the plurality of client computing devices to randomly assign themselves into the plurality of arms; providing, by the computer system and to each of the plurality of client computing devices, the plurality of rule sets and the assignment information, wherein each of the client computing devices is programmed to assign itself, based on the assignment information, to one of the plurality of arms and to implement the experiment using one of the plurality of rule sets that corresponds to the one of the plurality of arms; receiving, by the computer system, individual results for the experiment from the plurality of client computing devices; and determining, by the computer system, aggregate results for each of the plurality of arms of the experiment based on aggregations of the individual results.

Such a computer-implemented method can optionally include one or more of the following features. The computer-implemented method can further include determining, by the computer system, assignment probabilities for the arms of the experiment, wherein each of the assignment probabilities indicates a likelihood that client computing devices will be assign themselves to a particular arm of the experiment. The assignment information can include the assignment probabilities.

In another implementation, a computer-implemented method includes receiving, at a client computing device and from a computer system, a request to participate in an experiment, wherein the request includes assignment information and rules for implementing the experiment on the client computing device; assigning, by the client computing device, the user to one of a plurality of arms for the experiment based, at least in part, on the assignment information; performing, by the client computing device, the one of the plurality of arms of the experiment on the client computing device based, at least in part, on the rules; determining, by the client computing device, results for the experiment based, at least in part, on user behavior detected by the client computing device; and providing, by the client computing device and to the computer system, the results.

Such a computer-implemented method can optionally include one or more of the following features. The request can further include inclusion information for the experiment on the client computing device. The method can further include determining, by the client computing device, whether a user associated with the client computing device qualifies the participate in the experiment based, at least in part on the inclusion information. The assigning can be performed in response to determining that the user qualifies to participate in the experiment. The assignment information can include probabilities for each of the plurality of arms of the experiment. Performing the one of the plurality of arms of the experiment can include identifying, based on the rules, one or more times to output a message on the client computing device; determining, based on the rules, one or more messaging channels to use for outputting the message on the client computing device; and outputting, by the client computing device, the message on the client computing device at the one or more times and using the one or more messaging channels. The user behavior can be detected using one or more peripheral devices that monitor the user's physical activity and that are in communication with the client computing device.

Certain implementations may provide one or more advantages. For example, the platforms described throughout this document can, in certain implementations, allow for researchers to more accurately and effectively design experiments as compared to less flexible approaches. In particular, the platforms can, in certain implementations, allow researchers to more accurately determine parameters for an experiment, such as sample sizes for the experiment (number of users to be included in the experiment), numbers of arms for the experiment, and/or minimum thresholds for the desired statistical power for the experiment (statistical metric indicating the likelihood of detecting an effect if the effect actually exists).

For instance, researchers have traditionally not had ready access to information to determine the appropriate sample size to use for experiments to detect a certain effect size (e.g., 3% increase in number of users weighing themselves at least once per day) with a desired statistical power (e.g., 90%). In contrast, certain implementations of the platforms described in this document are able to obtain and determine, before the experimentation has even been run, such baseline information about the population that is to be tested.

In another example, the platforms can allow, in certain implementations, for experiments to be designed and performed across a large user base while preserving user privacy. By positioning the platforms between researchers and users to act as a privacy screen, the platforms can maintain the anonymity of users throughout every step of an experiment—from design to deployment to results—while still providing researchers with control over the experiment and access to the results. For instance, the platforms can restrict the minimum sample size for an experiment (and for arms of the experiment) to achieve certain privacy guarantees, which may be predetermined or may be determined at run-time using particular parameters for an experiment. The platforms can also aggregate and anonymize information about the population that is provided to researchers.

In a further example, features of platforms described in this document, in certain implementations, can be implemented in a decentralized manner, which can provide additional layers of anonymity and flexibility for the design and deployment of experiments. For example, instead of relying upon a centralized computer system or an experiment designer to randomly assign eligible users into different arms for an experiment, the assignment process can be offloaded to client computing devices that can randomly self-assign themselves to different arms. Such self-assignment of users to different arms of an experiment allows critical user data to remain private from the central computer system as well as just the researcher.

In another example of decentralized features in platforms, determinations as to whether users satisfy various inclusion/exclusion criteria to be included in an experiment can, in certain implementations, additionally be offloaded to the user's computing devices. For instance, a researcher looking into ways to increase the frequency with which users weigh themselves may provide inclusion criteria for the experiment that users need to have/use a Wi-Fi-accessible scale to participate in the experiment, and need to have a history of using it to weigh themselves. Instead of relying on a centralized computer system to maintain personalized information about users to determine whether users qualify to be part of the experiment, an platform can push such determinations out to client computing devices, which can maintain and/or have access to private user information. For instance, a computer system can transmit the example inclusion criteria (Wi-Fi-accessible scale and history of use) to client computing devices, which can be programmed to determine whether the corresponding user satisfy the criteria. In response, the user's computing devices can simply provide a binary response to assess inclusion in the experiment—yes or no—which can shield users' private information. In an instance with even stronger privacy guarantees, the device can keep whether its user is included in the experiment private. Communicating the total number of users who meet the inclusion criteria to the computer system can be done using differential privacy techniques.

In another example, the platforms described in this document can, in certain implementations, allow researchers to quickly and readily deploy experiments across a large user population. Rather than requiring researchers to solicit users to participate in the experiment, to administer and manage the experiment, and then to collate the results, the platforms, in certain implementations, allow researchers to deploy experiments without these technical hurdles, which could delay the experiment, increase costs, and pose potential risks to user privacy.

In a further example, the platforms can allow researchers to design and deploy experiments across a large user base under real life conditions. Researchers have deployed experiments under various test conditions (e.g., use of testing devices, use of testing applications, testing at particular locations) that may not otherwise be part of a user's normal life and that may not be part of the intended stimuli that is being tested. Such test conditions may cause the results of experiments to be skewed. In contrast, the platforms disclosed in this document can, in certain implementations, allow for experiments to be deployed within a preexisting framework for users, such as on client computing devices that users already use, such as smartphones, tablet computing devices, wearable devices; and with applications that are already installed and used on those devices (e.g., mobile fitness apps already installed on users' mobile computing devices). By deploying experiments in this way, less biased results can be obtained that reflect users' responses to the tested stimuli instead of to the testing framework that is being used to implement the experiment.

In another example, experiment outcomes can be generated and monitored in real time. Researchers can view specific outcomes that are being reached, whether a statistical significance is being attained, and/or other relevant details regarding an experiment in real time. In a further example, experiments can be modified, redeployed, and/or terminated before their scheduled end, such as in response to real time monitoring of the experiment outcomes.

User privacy can also be ensured. For example, platforms can be programmed to only use data that users have provided consent to be disclosed and used in results for an experiment. Additionally, platforms can be programmed to provide mechanisms for researchers to obtain additional user consent, in the event that it may be needed.

The details of one or more embodiments are set forth in the accompanying drawings and the description below. Other features and advantages will be apparent from the description and drawings, and from the claims.

### DESCRIPTION OF DRAWINGS

FIG. 1 is a conceptual diagram of an example system to provide an experimental platform.

FIGS. 2A-C are conceptual diagrams depicting an example use of a system to design, deploy, and determine results for an example experiment.

FIGS. 3A-B are conceptual diagrams of an example system using decentralized techniques for implementing an experiment.

FIG. 4 depicts an example system for providing an experimentation platform.

FIGS. 5A-B are flowcharts of example techniques for implementing aspects of an example experimentation platform.

FIGS. 6A-C are screenshots of example user interfaces that can be used as part an experimentation platform.

FIG. 7 is a block diagram of example computing devices that may be used to implement the systems and methods described in this document.

Like reference symbols in the various drawings indicate like elements.

### DETAILED DESCRIPTION

This document generally describes computer-based evidence generating and data interpretation platforms that can be used by users (e.g., researchers) to discover, test, and implement experiments (e.g., studies, tests, trials, evidence generating experiments). on client computing devices, such as experimental behavior-changing interventions that client computing devices can perform to test their effects on habit formation. Evidence generating and data interpretation platforms can include computer systems that can allow third party researchers to coordinate the design and deployment of experiments across client computing devices that correspond to participants in the experiments. Such computer systems can also receive and process results that are received from client computing devices, and can provide results to researchers.

For example, a health behavior researcher can use an experimentation platform to design parameters for an experiment that will test different intervention techniques for increasing the amount that users exercise. For instance, a first intervention technique may include notifying users when they have been sedentary for 45 minutes or longer, and a second intervention technique may involve providing users with incentives (e.g., money, points, and rewards) to exercise at particular times during the day. The experimentation platform can identify a population of users to include in the experiment and can push the first intervention out to a first group (first treatment arm of the experiment), the second intervention out to a second group (second treatment arm of the experiment), and a control intervention (e.g., no intervention) out to a control group (control arm of the experiment). Another group might be subjected to a combination of both interventions. The client computing devices can provide the interventions to users (e.g., output messages/notifications to users at particular times), record the resulting behaviors of the users (e.g., information indicating whether users exercised), and provide the results to the experimentation platform, which can analyze and aggregate the results for the researcher. For example, the results may indicate that the first intervention was effective (positive outcome and statistically significant result) for people over the age of 50 (and less effective for other age groups in a statistically significant way) and that the second technique was effective for people between the ages of 18-35 (and less effective for other age groups in a statistically significant way).

Evidence generating and data interpretation platforms can allow for a complete decoupling between designing and deploying an experiment (e.g., tests, trials, studies, evidence generating operation) to a population, which retains both user privacy and the ease with which experiments can be performed. For example, by positioning platforms as privacy screens between researchers and participants in experiments, researchers can be involved with experiment design without having to be involved, in any capacity, with then deploying the experiments that they have designed other than asking the platform to perform the deployment. This contrasts with situations in which a designer of an experiment would have full information about the population they are targeting, this flexibility comes at the cost of a complete privacy disclosure of the population members to the experiment designer.

Users (e.g., researchers) can use evidence generating and data interpretation platforms to better and more accurately design experiments (e.g., studies, tests, trials, evidence generating operations) on a population of users. For example, experimentation platforms can provide features (e.g., an API) through which experiment designers can query characteristics of the population, which can allow the designer to define the parameters of the experiment and measure the outcomes. For instance, experiment designers can provide some parameters for their experiments, such as a desired outcome to be observed and the desired statistical power of detecting an effect, and experimentation platforms can determine other parameters that would otherwise be unknowable for a designer, such as the sample size that should be used for the experiment. Platforms can provide these features while preserving user privacy and preventing experiment designers from gaining any information that would uniquely identify a member of the population.

Evidence generating and data interpretation platforms like those discussed here can additionally provide centralized and decentralized techniques for partitioning populations into different arms for experiments, such as fixed arms (e.g., case/control) and/or dynamic arms (e.g., using multi-armed bandit strategies). For example, experimentation platforms can partition users into different arms of an experiment (centralized partitioning) and/or can offload such determinations to individual client computing devices, which can determine which arm of an experiment corresponding users should be placed (decentralized partitioning). Such partitioning can be performed through experimentation platforms as specified by the designer through indirect rules that are evaluated on the population without a designer's direct interaction. This client-side partitioning may occur alone or in combination with server-side partitioning, such as a service system using profile information about users that they may not consider sensitive (e.g., age and/or gender) to determine which devices to be targeted for the subsequent client-side partitioning.

Evidence generating and data interpretation platforms may additionally restrict designers to accessing experiment results in aggregate form only, which can preserve user privacy. Additionally, platforms may provide results in a decentralized fashion in which results are provided to researchers directly from client devices. In such instances, instead of having information relayed to the experimental designer from a centralized system/database storing information that may identify users, results can sourced from the users' devices in a distributed fashion conforming to the privacy settings set by each user.

As described above, evidence generating and data interpretation platforms described throughout this document can provide a variety of advantages in certain implementations. For example, such experimentation platforms can be outsourced to allow for third parties (e.g., external research institutions) to design and deploy experiments on target populations, and to analyze results for the experiments based on sensitive and/or private user information being protected from disclosure to third parties (researchers).

Evidence generating and data interpretation platforms can be used for a variety of contexts, such as to perform experiments related to user behavior. For example, the evidence generating and data interpretation platforms described in this document can be used, in certain implementations, to test the effectiveness of interventions (e.g., messaging, notifications, incentive offers) on health behavior, such as exercising habits, eating habits, sleeping habits, medical management adherence, clinical trial protocol compliance, medication adherence and/or other metrics of that are indicative of behavior that could positively or negatively impact user health. Although health behavior examples are used throughout this document to illustrate uses of the disclosed experimentation platforms, other implementations, applications, and uses of the disclosed experimentation platforms are also possible. Additionally, although example evidence generating and data interpretation platforms are described and depicted in the figures as experimentation platforms, other types and uses of platforms are also possible, such as for designing specific types of experiments, like tests, trials, studies, and/or other types of activities across a population of users to generate evidence. The features that are described with regard to the example experimentation platforms can be extended to and used as part of all evidence generating and data interpretation platforms.

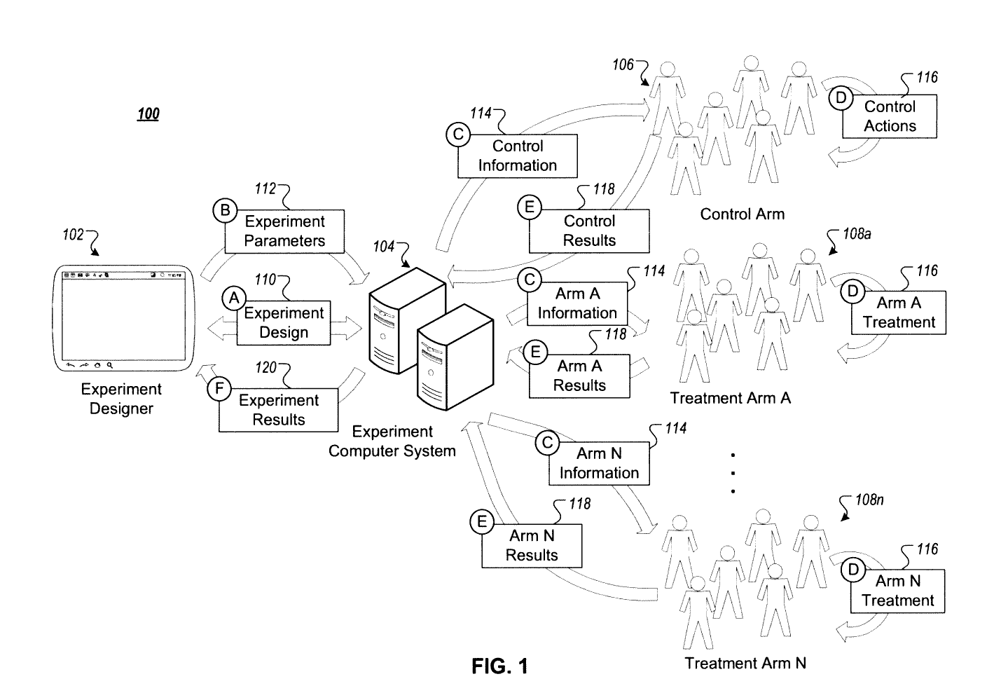

FIG. 1 is a conceptual diagram of an example system 100 to provide an experimental platform. The system 100 is depicted as including an example experiment designer computing device 102 that is used by an experiment designer/researcher to design, deploy, and view results for an experiment. The system 100 also includes an example experiment computer system 104 that is programmed to assist in experiment design (e.g., determine the experiment parameters, provide de-identified population information), to deploy experiments across a population of users, and to provide results to the experiment designer device 102 in a manner that preserves user privacy.

The system additionally includes example experiment participants 106-108 who are partitioned into a control arm 106 and treatment arms A-N 108a-n. Although not depicted, each of the example participants 106-108 can be associated with one or more client computing devices that interface with the experiment computer system 104 (and, in some implementations, the experiment designer device 102) to obtain information for the experiment, to implement the experiment, and to report results for the experiment.

The experiment designer computing device 102 and the client computing devices that are associated with the participants 106-108 can be any of a variety of appropriate computing devices, such as mobile computing devices (e.g., smartphones, media players, tablet computing devices, personal digital assistants), desktop computers, laptops, connected devices such as pedometers, glucometers, scales and other health tracking devices and/or wearable computing devices (e.g., augmented reality headset devices, smartwatches). The experiment computer system 104 can include one or more of any of a variety of appropriate computing devices, such as computer servers, cloud-based computer systems, desktop computers, mobile computing devices, and/or any combination thereof. The system 100 can additionally include one or more networks (e.g., internet, wireless networks (e.g., Wi-Fi networks, mobile data networks), wired networks, local area networks (LAN), wide area networks (WAN), virtual private networks (VPN), or any combination thereof) through which the computing devices/systems 102-108 can communicate with each other.

As depicted in step A (110), the experiment designer device 102 can interact with the experiment computer system 104 to design an experiment. For example, the experiment designer device 102 may initially request information about the population of users 106-108, such as general demographic information (e.g., percentage of users by gender, age range) and behavior habits (e.g., percentage of users that exercise regularly, irregularly, or not at all). The computer system 104 can obtain that information (by accessing a data repository of user information and/or by polling computing devices associated with the users), aggregate and anonymize it (e.g., using k-anonymization techniques), and can provide it to the experiment designer 102. The experiment designer 102 may then designate some parameters for the experiment, such as inclusions/exclusion criteria for the experiment (e.g., only include users who have fitness trackers, current or past communication, current or past social behavior, current medical conditions (e.g., patient with diagnosed hypertension), current health contexts (e.g., diagnosed with type II diabetes within past 15 days)), a desired outcome for the experiment (e.g., increase exercise frequency by 5%), and a minimum statistical power for the experiment (e.g., 80%, 90%, 95%). The experiment computer system 104 can use the initial parameters to determine a variety of details about the experiment that would not otherwise be available to the designer 102, such as a number of users who satisfy the inclusion criteria and/or a minimum sample size for the experiment (e.g., based on information about the qualifying user base (e.g., current statistical exercise information for the users), the expected outcome for the experiment, and the statistical power required).

Additionally, the experiment computer system 104 can determine whether an experiment as designed by the experiment designer 102 would pose privacy risks to participants, such as by determining a minimum sample size that is needed to ensure k-anonymous results are provided to the experiment designer 102. The experiment computer system 102 can compare the minimum sample size to ensure user privacy against the minimum sample size to perform the experiment to obtain the results desired by the researcher (as well as the size of the population that satisfies the inclusion/exclusion criteria) to determine whether an experiment can proceed.

The experiment computer system 104 can provide information that is determined regarding the experiment, such as information indicating whether the experiment can continue, ranges of permissible sample sizes, and/or suggested variations on the experiment parameters, to the experiment designer computing device 102. The back and forth between experiment designer computing device 102 and the experiment computer system 104 can proceed until the researcher is satisfied with the experiment parameters, which can be provided to the experiment computer system 104 to initiate the experiment, as indicated by step B (112).

In addition to the experiment parameters mentioned in the preceding paragraphs, the experiment designer 102 can designate a number of arms for the experiment and particular experiments to be run under each of the arms. In the depicted example, the experiment designer 102 has designated a single control arm 106 and multiple treatment arms A-N 108a-n. Any number of control and/or treatment arms can be designated. The experiment computer system 104 can send appropriate information for each of the arms 106-108 of the experiment, as indicated by step C (114). The information can include rules to be followed by the client computing devices 106-108 to implement each of the arms of the experiment and/or content (e.g., messages, images, videos, audio files) to be presented to users within the arm.

The users can be assigned to the arms 106-108 in any of a variety of appropriate ways. In a first example, the experiment computer system 104 can partition the population of users passing the inclusion/exclusion criteria into the arms 106-108 (centralized partitioning). Such centralized partitioning can be done in any of a variety of ways to ensure sufficiently even distribution of users across the arms (e.g., stratified random assignment) of the experiment according to one or more factors, such as demographic information (e.g., age, gender), current status along one or more metrics that are being evaluated (e.g., exercise frequency), behavioral attributes (e.g. propensity to track blood pressure in the morning) and/or other appropriate factors. The computer system 104 may restrict the use of such information about users (e.g., demographic information, behavioral attributes) to information that users have consented (provided permission) to being made available to the computer system 104 and/or to experiment designers.

In a second example, the experiment computer system 104 can outsource the random assignment to the client computing devices 106-108 that are associated with the users (decentralized assignment). For instance, the computer system 104 can provide the information for all arms of the experiment to each of the client computing devices and additional information to guide the client computing devices in allocating themselves to one of the arms 106-108. For instance, such additional information can include distribution probabilities for each of the arms 106-108 that can be used by the client computing devices to determine an appropriate placement (e.g., random assignment based on weighted values for the arms 106-108 that are derived from the distribution probabilities).

In a third example, the experiment computer system 104 can provide de-identified information about the population of users to the experiment designer 102 and the experiment designer 102 can directly perform the random assignment of the users into the arms 106-108. Other ways to assign the users into the arms 106-108 are also possible, such as combinations of the first, second, and/or third example.

Once the information for the arms 106-108 has been received, the client computing devices can proceed to perform actions according to the arm of the experiment within which they are located, as indicated by step D (116). For example, each of the treatment arms A-N may provide different types of messages (e.g., text messages, emails, push notifications) and/or timing for the presentation of such messages (e.g., fixed times (e.g., morning vs. evening), times triggered by some event (e.g., when user opens application, around time user typically weighs himself/herself, when user is inactive for more than threshold period of time)) to users to encourage/discourage particular types of behavior. The control arm may provide users with a neutral experience (e.g., unrelated messaging) that is intended to not encourage/discourage any types of behavior.

The client computing devices can, directly and/or indirectly through communication with other devices/system (e.g., activity monitors, external data sources of user behavior), monitor user behavior in relation to the actions/treatments that are being provided. During and/or at the conclusion of the experiment (e.g., end of the experiment time period, user has reached a target result), the client computing devices can provide results for to the experiment computer system, as indicated by step E (118). Although not depicted, in some implementations the client computing devices can provide the results to the experiment designer computing device 102 with, for example, appropriate de-identification and aggregation of data to protect user privacy.

The experiment computer system 104 can receive the results from the client computing devices, can aggregate and anonymize the results, and can provide the aggregated, anonymized results to the experiment designer computing device 102, as indicated by step F (120).

Experimentation platforms provided by the system 100 can provide a way for a larger and more permanent group of users to be engaged as participants across multiple experiments. This can lead to a user-base with more users than would otherwise be present from a single experiment, which can reduce the costs associated with performing experiments, such as recruiting costs. The experimentation platform can provide a scale that can allow the experiment computer system 104 to use any of a variety of appropriate techniques to keep users engaged and/or reward participation, such as awarding points and/or money to users for participating in experiments.

The experiment computer system 104 may also leverage data across different experiments, including using data that was collected before an experiment was even designed or proposed by the experiment designer computing device 102. For example, the computer system 104 can store data from other experiments with other researchers and/or general user data that the platform collects with user permission (e.g., data that shows a user's level of physical activity, sleep patterns, diet), and can use this stored data with regard to the experiment being designed by the experiment designer computing device 102 (e.g., assist in determining experiment parameters, provide insights into user behavior, estimate the likelihood of the desired results being observed).

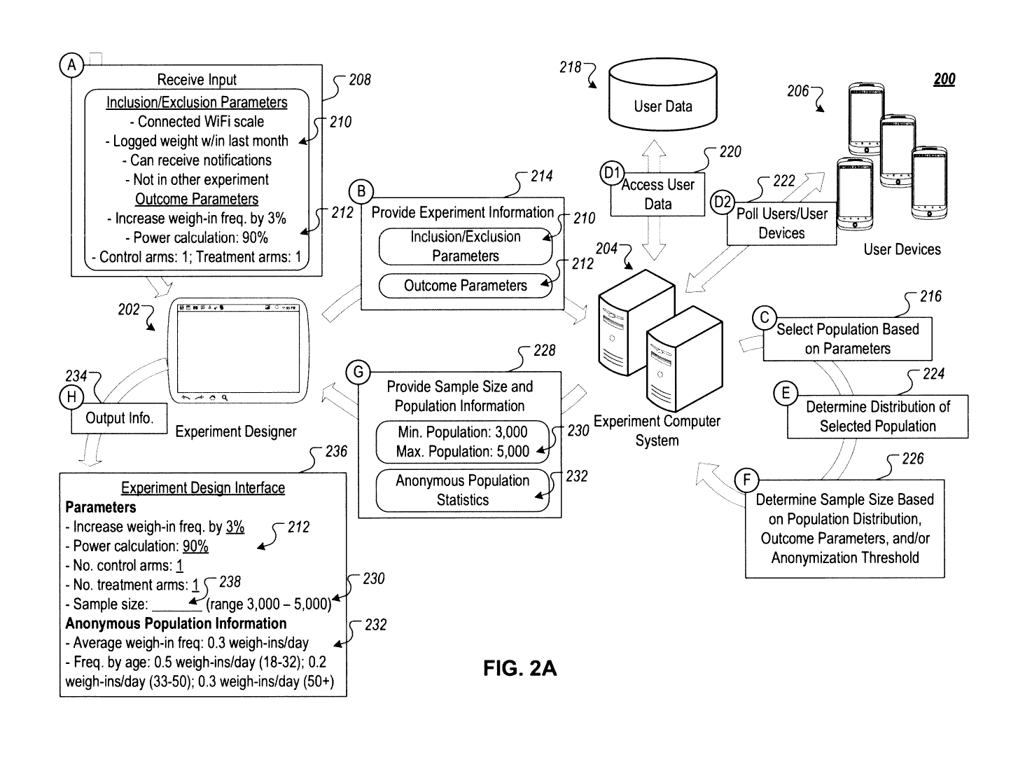

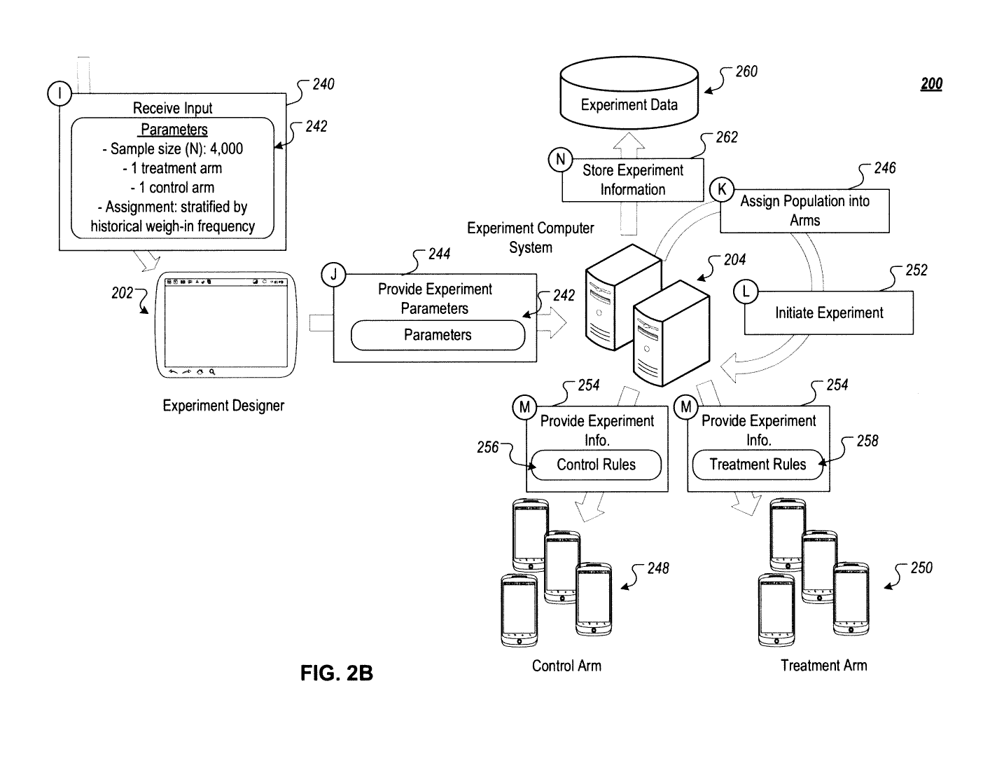

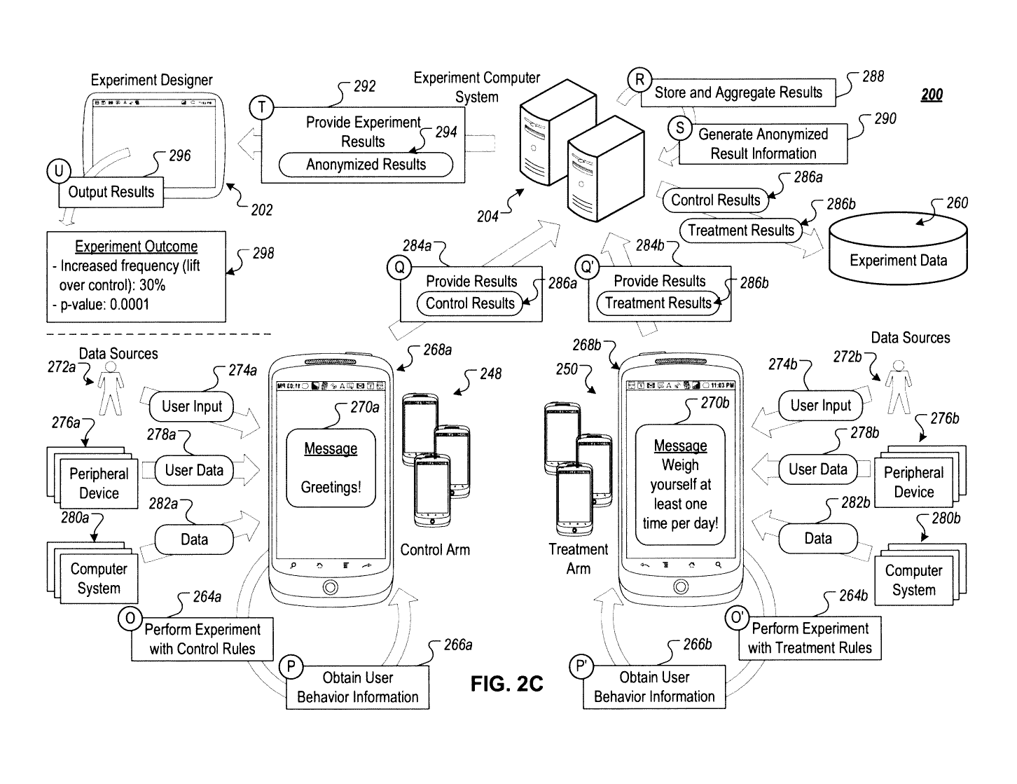

FIGS. 2A-C are conceptual diagrams depicting an example use of a system 200 to design, deploy, and determine results for an example experiment. The example system 200 is depicted as including an experiment designer computing device 202, an experiment computer system 204, and user computing device 206. The system 200 can be similar to the system 100, and the experiment designer computing device 202, the experiment computer system 204, and the user computing device 206 can be similar to the experiment designer computing device 102, the experiment computer system 104, and the client computing devices described in association with the arms 106-108, respectively.

Referring to FIG. 2A, the experiment designer computing device 202 receives input from a user of the device 202 that designates some parameters 210-212 for an experiment, as indicated by step A (208). In this example, the parameters that are input by the user include inclusion/exclusion parameters 210 for desired participants to be included in the experiment and outcome parameters 212 for outcomes that are desired from the experiment. The inclusion/exclusion parameters 210 in this example include a user's computing device being connected to a Wi-Fi scale, having logged the user's weight at least once within the previous month, being configured to receive/output notifications to the user (e.g., device settings permit a mobile app running on the client computing device to output push notifications), and for users to not currently be involved in another experiment. The outcome parameters 212 in this example include a target/tested effect size for an example metric (increase weigh-in frequency by 3%), a statistical power that is required for detecting the effect (90%), a number of control arms to be used in the experiment (1 control arm), and a number of treatment arms to be used for the experiment (1 treatment arm). The platform can also provide a way to specify the required significance level (usually assumed to be 0.05).

The input can be received by the experiment designer computing device 202 using any of a variety of appropriate user interfaces, such as graphical user interfaces (GUI), text-based user interface, voice user interfaces (VUI), or any combination thereof. The experiment designer computing device 202 is programmed to provide a user interface through which a user can provide the input, such as through an application (e.g., mobile app, web application) that is being executed by the experiment designer computing device 202.

The experiment designer computing device 202 can provide the experiment information, such as the inclusion/exclusion parameters 210 and the outcome parameters 212 for the experiment, to the experiment computer system 204, as indicated by step B (214). Such experiment information can be transmitted over one or more communication networks, such as the internet, wireless networks (e.g., Wi-Fi networks, mobile data networks, cellular networks), LANs, WANs, VPNs, or any combination thereof.

In response to receiving the experiment information, the experiment computer system 204 can select an available population of users that qualify for the experiment based on the inclusion/exclusion parameters 210, as indicated by step C (216). The experiment computer system 204 can do this in a variety of ways. For example, the experiment computer system 204 can access user data from a user data repository 218 that is accessible to the computer system 204, as indicated by step D1 (220), and evaluate the inclusion/exclusion parameters 210 against the user data. For instance, the user computing devices 206 can be configured, with user permission, to periodically provide information to the experiment computer system 204 (and/or to other computer systems) that can be stored in the user data repository 218, such as user information (e.g., demographic information, user consent to participate in experiments), health behavior information (e.g., log of recent weigh-ins, fitness tracker information, dietary information), and/or information about settings on the user devices 206 (e.g., permissions granted to mobile apps running on the computing devices 206, such as permissions to provide push notifications, access the user's location information, pull data in the background, push data in the background). The user data 218 can also include data that has been obtained from previous experiments performed using the experiment computer system 204.

In another example, the experiment computer system 204 can select the qualifying population for the experiment by polling the user devices 206, as indicated by step D2 (222). For instance, the computer system 204 can provide some or all of the inclusion/exclusion parameters 210 to the user devices 206, which can determine, based on user data that is stored locally on the user devices 206 and/or restricted to being accessed by the user devices 206 (e.g., data that is stored with other remote computer systems that are accessible to the user devices 206), whether a corresponding user qualifies for the experiment. In such instances, the user devices 206 can provide a response to the computer system 204 indicating whether the user qualifies without providing any of the underlying data that was used by the user devices 206 to make the determination. Such configurations can provide a privacy screen between users and the experiment computer system 204, and can help increase user privacy. Additionally, results from such determinations by the user devices 206 can be communicated anonymously to the computer system 204, such as through the use of differential privacy techniques.

In another example, the computer system 204 polling the user devices 206 (step D2 222) can include obtaining user data from the user devices 206 that can be used by the experiment computer system 204 to determine whether corresponding users qualify for the experiment based on the inclusion/exclusion parameters 210. For example, computer system 204 may request particular user data from the user devices 206 that can be used to determine whether corresponding users qualify for the experiment. Such polling of the user devices 206 for user data to be used by the computer system 204 may be performed in combination with accessing user data from the user data repository 218 (step D1 220).

In some implementations, the experiment computer system 204 can additionally poll the user devices 206 for user consent to be included in the experiment. For example, for users that the experiment computer system 204 determines qualify for the experiment based on the inclusion/exclusion parameters 210, the computer system 204 can poll their corresponding user devices 206 for user consent to participate in the experiment. In some instances, users may have previously provided consent to participate in all and/or particular types of experiments (e.g., prior content to be included in all experiments with the goal of improve activity levels). In such instances, the user devices 206 may be able to respond to the permission request from the computer system 204 without input from the corresponding users.

In instances where users have not provided prior consent (and where consent may be needed to include users within an experiment), the user devices 206 can be programmed to request consent from users, such as through notifications, messages, and/or alerts that may be output by the user devices 206. The user devices 206 can receive user input from consent requests, such as through any of a variety of appropriate user interfaces (e.g., GUIs, VUIs), and can provide information to the experiment computer system 204 indicating whether users have consented to being part of the experiment.

The experiment computer system 204 can determine one or more statistical distributions (e.g., normal distribution) for the selected population along one or more metrics (e.g., weigh-in frequency, activity level, hours of sleep per night, use of a food diary) being tested for the experiment, as indicated by step E (224). Statistical distributions can detail the distribution of values for a population along for one or more metrics, and can include information identifying the mean and the standard deviation. The computer system 204 can use the statistical distributions to identify the current state of the population that would be tested under the experiment and to determine parameters for the experiment that the experiment designer would otherwise be unable to ascertain, such as the sample size that is needed to generate results with the desired effect size (e.g., increase weigh-in frequency by 3%), attaining the desired statistical power (e.g., 90%), and the desired number of arms of the experiment (e.g., 1 control arm and 1 treatment arm).

The computer system 204 can determine the distribution of the selected population using data for the users that is accessed from the user data repository 218 and/or data that is obtained for the users from the user devices 206. For example, the computer system 204 may initially check the user data repository 218 for weigh-in frequency information for each of the users that are included in the selected population and, if the information is unavailable or otherwise unusable (e.g., data is outdated), the computer system 204 can request weigh-in frequency information from corresponding ones of the user devices 206. For users who are included in the selected population but who do not have any data (e.g., weigh-in frequency information), the computer system 204 may take a variety of steps, such as excluding the users from the determined distribution, assigning a null/zero value for the users, dropping the users from the selected population, and/or assuming value (e.g., weigh-in frequency value) for the users based on, for example, values for other, similar users.

The computer system 204 can determine additional parameters (e.g., sample size) for the experiment based on the population distribution and the parameters that have already been provided by the experiment designer computing device 202, as indicated by step F (226). For example, the computer system 204 can determine the minimum sample size that should be used to detect the desired effect size (e.g., increase weigh-in frequency by 3%) with the required statistical power (e.g., 90%) when using the designated number of arms for the experiment (e.g., 1 control arm, 1 treatment arm) for the selected population (given the selected population's determined distribution) that has been determined to qualify for the experiment based on the inclusion/exclusion criteria (e.g., connected to Wi-Fi scale, logged weight within last month, settings to receive notifications, and not in another experiment). A variety of techniques can be used by the computer system 204 to determine the minimum sample size value given these parameters. For example, for detecting a difference in mean between two populations, the computer system 204 can determine the minimum sample size using Equation 1 below. In Equation 1, n is the minimum sample size, Z_{a/2} is the critical value in the determined distribution of the outcome variable corresponding to the desired statistical power, a is the empirical standard deviation for outcome variable, E is the effect size expected on the outcome for the experiment (difference between μ (mean of determined distribution for the selected population) and x (desired mean value to result from the experiment)):

$$n = {( \frac{{Z}_{\frac{α}{2}} * σ}{E} )}^{2} \qquad EQUATION 1$$

In another example, the computer system 204 can determine the minimum sample size based on known values for the statistical power, the noise level (standard deviation), and the estimated effect size. Statistical power is the probability of detecting a true effect, which may be easier to detect with a bigger effect size than a smaller effect size. Similarly, a larger sample size can provide a higher level of certainty that the results reflect the truth (e.g., not attributed to sampling error), meaning the effect that is detected is true. A greater level of noise can make it more difficult to detect signals and effects.

In a further example, the computer system 204 can determine a minimum effect size to be detected based on known values for the statistical power, the sample size, and the noise level (standard deviation of the distribution of the outcome variable). For instance, a researcher may know the sample size is given (e.g., all eligible users in the use-base) and want to determine an effect size that is likely to be detected with the content of a given experiment. For example, if a researcher wants to assess the effects of monetary rewards in increasing the level of exercise, the researcher could aim at increasing the number of steps by at least X per day (e.g., increase of 200 steps/day) and therefore know (e.g., from known literature on rewards effect) that awarded rewards should be in the ball park of $2/week to generate such effect size. Depending on the distribution of the outcome variable (e.g., normal) and the type of experiment being performed (e.g., detecting changes in population means), the platform enables computing the power for a variety of tests (z-test, t-test, ANOVA, Chi-Square Contingency Tables, Survival Analysis, Non-Parametric Analysis) or determine parameters (e.g., effect size, sample size) to obtain a target power.

The computer system 204 can also determine a minimum sample size that is needed to provide at least a threshold level of anonymity for the participants in the experiment as part of step F (226). The computer system 204 can use any of a variety of techniques to determine a minimum number of users that are needed to ensure anonymity of users who have been de-identified in data (e.g., results, background information about the population) that may be provided to the experiment designer computing device 202. For example, the researcher associated with the experiment designer computing device 202 may want to examine results for the experiment along not only the metric that is being tested, which in the depicted example is the frequency of weigh-ins for users, but also along other dimensions, such as demographics (e.g., age, gender, weight), other user information (e.g., profession, education, marital status, family), other health behavior information (e.g., activity level, sleep patterns, diet), specific health condition information (e.g. diagnosed with type 2 diabetes, taking a prescribed medication) and/or external factors (e.g., climate/weather, time of year, proximity to green space, geographic location). For every detail about the population that is provided to the experiment designer computing device 202, the computer system 204 may need to increase the sample size to avoid situations in which the researcher can segment the population into small enough subsets that the identity of users may be revealed. The computer system 204 can use any of a variety of appropriate techniques to evaluate a minimum sample size to ensure user anonymity, such as k-anonymity techniques and/or differential privacy techniques.

The computer system 204 can additionally determine a maximum sample size the computer system 204 is able to offer for the experiment based, at least in part, on the size of the selected population as part of step F (226). For example, the computer system 204 may determine the maximum sample size for the experiment is the size of the selected population (users who satisfy the inclusion/exclusion criteria). In another example, the computer system 204 may determine the maximum sample size based on the size of the selected population and on the status and size of other experiments that are being coordinated by the experiment computer system 204 (e.g., other experiments that are being planned and/or performed by the computer system 204). For instance, the computer system 204 can manage and deploy experiments for multiple experiment designers across the population of user device 206. The computer system 204 may take into account the experimentation load on the network of users associated with the user devices 206 when setting a maximum sample size for the experiment so as to ensure users will be available to participate in experiments for other researchers (e.g., hold back a threshold percentage/number of users (e.g., 20% of users) from participating in experiments) and/or that users are not participating in too many experiments (e.g., no more than 1, 2, 3, etc. concurrent experiment per user) and/or with too much frequency (e.g., no more than 1 experiment per month, quarter, year) and/or have participated in a specific previous experiment (e.g., an experiment that would potentially taint responses to the new experiment).

The computer system 204 may additionally adjust the determined minimum and maximum sample sizes based on any of a variety of factors, such as historical engagement with experiments by the population as a whole and/or by the individual users who are included in the selected population. For example, if on average only 80% of the users participating in an experiment actually engage with the experiment in a manner that has provided useful results (e.g., access application and/or features that are part of the experiment), then the computer system 204 may increase the minimum sample size to account for an expected lack of engagement by a portion of the participants. For instance, if the minimum sample size is determined to be 3,000 users and the computer system 204 has determined that only 80% of the participants have a threshold likelihood of providing useable data for the experiment, the computer system 204 can determine adjust the minimum sample size to 3,750 (3,000/0.8) so that data will likely be obtained for 3,000 participants (3,750*0.8) for the experiment.

The computer system 204 can determine the likelihood that users within the selected population will participate in the experiment in a manner that will provide useable data for the purpose of the experiment based on a variety of factors, such as historical participation for the population of all users, historical participation of the particular users within the selected population for the experiment, historical participation for experiments testing similar metrics (e.g., other experiments testing weigh-in frequency), historical participation for experiments using similar interventions (e.g., messaging, incentives), historical participation for experiments over similar timeframes (e.g., experiments having a similar duration), and/or other appropriate factors.

The computer system 204 can use the determined maximum and minimum sample sizes to provide the experiment designer computing device 202 with a range of sample sizes that the researcher can select for the experiment. This sort of information (minimum and/or maximum sample sizes) from the computer system 204 can be helpful to researchers in guiding the design of their experiments. For example, in cases where rewards for the experiments will being given to participants by the researcher, such information can allow the researcher to explore tradeoffs between, for example, costs (e.g., expensive of the rewards based on sample size and reward/participant) and statistical power (e.g., larger sample size can be more likely to detect an effect). The computer system 204 can also aggregate and anonymize information about the selected population, such as information about the metric(s) to be evaluated for the experiment (e.g., weigh-in frequency) and/or demographic information regarding the selected population, to provide to the experiment designer computing device 202. As indicated by step G (228), the experiment computer system can provide the sample size range information 230 and the anonymized population statistics 232 to the experiment designer computing device 202.

The experiment designer computing device 202 can output the information that is received from the computer system 204, as indicated by step H (234). For instance, an example user interface 236 that can be output by the experiment designer computing device 202 depicts the outcome parameters 212 for the experiment, the possible range of sample sizes 230 that can be used for the experiment, an input field 238 through which the researcher can designate a sample size for the population, and example anonymized information 232 about the selected population that would be used for the experiment. The user interface 236 can permit the researcher to further modify the outcome parameters 212 (and/or other parameters, such as the inclusion/exclusion parameters 210, which are not depicted in the interface 236) and to submit them to the computer system 204 for further evaluation. For example, the steps A-H can be repeatedly performed by the experiment designer computing device 202, the experiment computer system 204, and/or the user devices 206 until the researcher is satisfied with the design for the experiment.

Although not depicted in the example in FIG. 2A, the computer system 204 can determine that the experiment as designed by the computing device 202 is unable to proceed and can provide such an indication to the computing device 202 (e.g., instead of providing the information 230, 232 at step H (228), the computer system 204 can provide information indicating that the experiment is unable to proceed). For example, the computer system 204 can determine whether the experiment is able to proceed based on the size of the selected population and the determined minimum and/or maximum sample sizes. For instance, if the determined minimum sample size is greater than the size of the selected population (the users who qualify for the experiment based on the inclusion/exclusion parameters), then the computer system 204 may determine that the experiment is unable to proceed as designed. If such an experiment were to proceed, it could pose a risk to user privacy and/or could produce results without the minimum desired statistical power.

In situations where the computer system 204 determines that the experiment is unable to proceed on the selected population, the computer system 204 can repeat the steps C-F with using variations of the inclusion/exclusion parameters 210 and/or the outcome parameters 212 (e.g., dropping parameters, lowering parameter values) to identify possible suggestions for alternate parameters for the experiment that the researcher could use. The computer system 204 can provide information about alternate parameters that are determined to be possible to use for the experiment to the experiment designer computing device 202, in addition to an indication that the experiment is unable to proceed as originally designed. Such information can be output by the computing device 202, for example, in the interface 236.

Referring to FIG. 2B, the experiment designer computing device 202 can receive input that includes finalize parameters 242 for the experiment, as indicated by step I (240). For example, based on steps A-H, the researcher using the computing device 202 can arrive at a finalized set of parameters for the experiment, including a sample size that is within the permissible range of sample sizes as determined by the computer system 204. For instance, the example sample size of 4,000 that is included in the parameters 242 is within the range of permissible sample sizes 3,000-5,000, as depicted in FIG. 2A. The experiment designer computing device 202 can be programmed to restrict the sample size parameter that is input by the user (experiment designer) of the device 202 to values that are within the permissible range of values.

The experiment designer computing device 202 can provide the parameters 242 to the experiment computer system 204, as indicated by step J (244).

In response to receiving the parameters 242, the experiment computer system 204 can designate a segment of the selected population to participate in the experiment based on the parameters 242 (e.g., sample size, inclusion/exclusion parameters, outcome parameters) and can randomly assign the designated segment of the selected population into arms for the experiment, as indicated by step K (246). For instance, in the example depicted in FIG. 2B, the computer system 204 can designate 4,000 users from the selected population (users who satisfy the inclusion/exclusion criteria for the experiment) for the sample to be used for the experiment based on the parameters 242 including a sample size of 4,000 for the experiment.

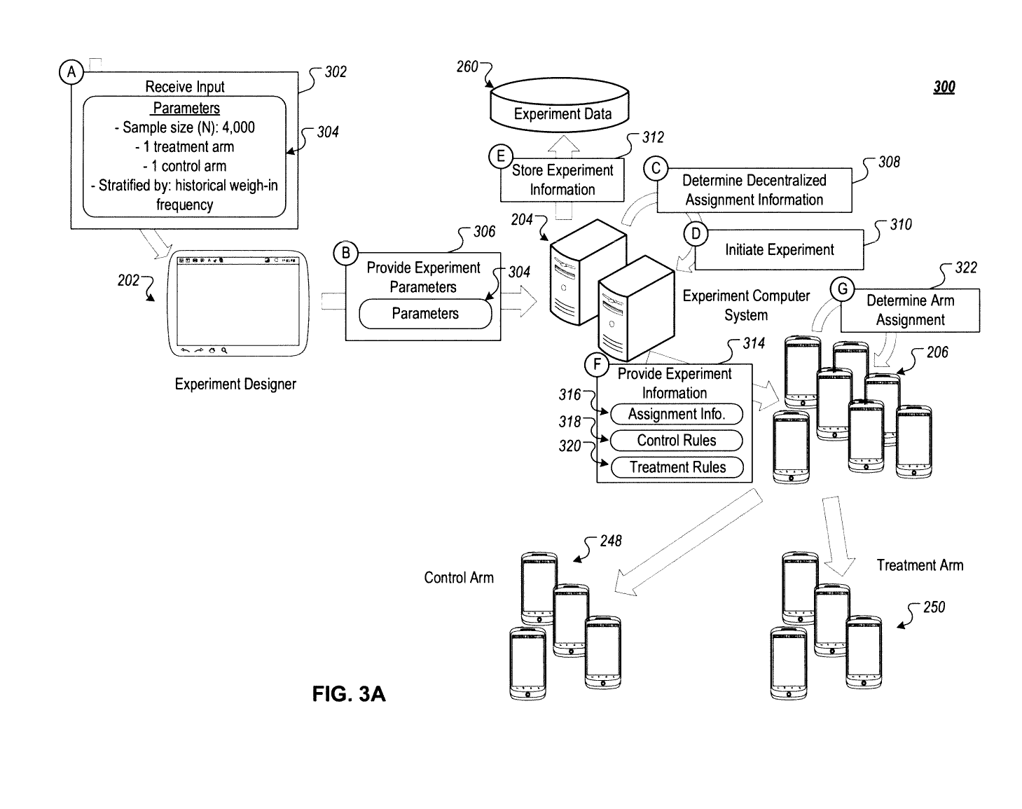

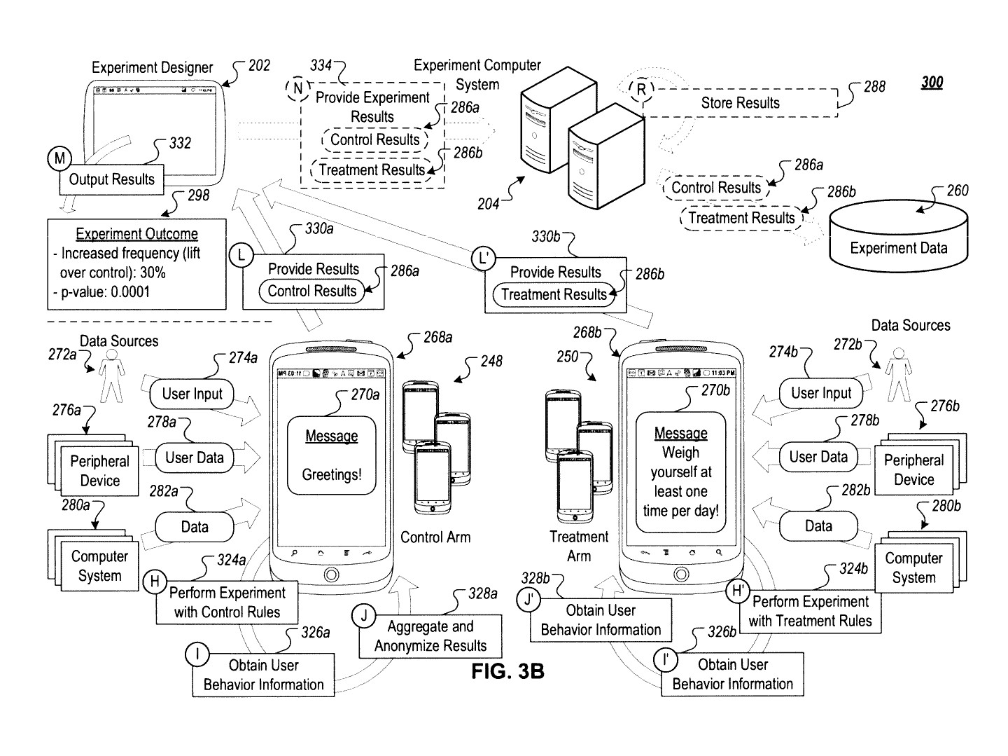

Designating users for the experiment and/or randomly assigning these users into different arms of the experiment can be performed in a variety of ways, such as in centralized and/or decentralized manners. For example, the computer system 204 can perform centralized designations and assignment of the population of participants for an experiment. In another example, the computer system 204 can provide the experiment designer computing device 202 with de-identified information about the selected population and can permit the experiment designer to perform centralized designation and assignment of the users into different arms of the experiment. In another example, the computer system 204 can offload the designation and assignment of users to the computing devices 206, which can perform these operations in a decentralized manner across the computing device 206. FIG. 2B depicts an example centralized designation and assignment by the computer system 204. FIGS. 3A-B depict an example decentralized designation and assignment by client computing devices (e.g., the user computing devices 206).

In the depicted example, the computer system 204 can designate and assign 4,000 users from the selected population into a control arm 248 and the treatment arm 250 for the experiment. The computer system 204 can use any of a variety of appropriate technique to do this, such as selecting groups of users so that the experiment arms 248-250 have similar population distributions along one or more metrics (e.g., through using the population distribution determined in step E (224)), random selection and assignment of users to the arms 248-250, and/or other appropriate techniques. The computer system 204 can designate groups of users so that the arms 248-250 have the same/similar size or different sizes.

Once the computer system 204 has determined the users to be included in the various arms of the experiment, such as the example control arm 248 and treatment arm 250, the computer system 240 can initiate the experiment, as indicated by step L (252). The computer system 204 can initiate the experiment by generating rules and other experiment information (e.g., message content) that can be provided to and used by the computing devices that are associated with the users who are included in the experiment. For example, the computer system 204 can generate rules that the computing devices included in the arms 248-250 will interpret/execute to determine when and how to provide health behavior interventions (e.g., messages, alerts, push notifications, incentives).

The computer system 204 can provide experiment information, such as control rules 256 and treatment rules 258, to user computing devices each of the arms 248-250 for the experiment, as indicated by step M (254). The devices in the arms 248-250 can use the information to initiate and implement the experiment on the computing devices.

The computer system 204 can additionally store experiment information in an experiment data repository 260, as indicated by step N (262). A variety of details can be stored as experiment information, such as the experiment parameters 242, unique identifiers for the experiment designer computing device 202 (and/or a user/organization associated with the device 202), information identifying users and/or their associated computing devices included in each of the arms 248-250, information identifying users who qualified for the experiment but who were not included in the arms 248-250, and/or other appropriate information. The computer system 204 can store information about users in the experiment data repository 260 using anonymous identifiers that mask the users' identities and other identifying information about the users.

Referring to FIG. 2C, the computing devices can perform operations to implement their respective arms 248-250 of the experiment, as indicated by steps O (264a) and O′ (264b), and can obtain user behavior data, as indicated by steps P (266a) and P′ (266b). The user computing devices that are part of the arms 248-250 can perform a variety of operations as part of the experiment, such as collecting user data as part of the experiment, determining when to perform interventions (e.g., time of day, following particular levels of activity and/or inactivity by the user), determining how to perform interventions (e.g., encouraging message, provide incentive offers), and/or implementing the interventions (e.g., outputting messages, providing reminders, push notifications). Such determinations can be made based on a variety of factors, such as the experiment information that is provided by the computer system 204 (e.g., the control rules 256, the treatment rules 258), the user behavior information that is obtained (e.g., weigh-ins, activity levels), and/or other external data sources (e.g., weather conditions, news events).

For instance, FIG. 2C depicts an example user computing device 268a that is part of the control arm 248 (associated with a user included in the control arm 248 and using the control rules 256) and an example user computing device 268b that is part of the treatment arm 250 (associated with a user included in the control arm 250 and using the control rules 258). In this example, the control computing device 268a outputs a greeting message 270a, which is intended to not have a direct effect on weigh-in behavior and can be used to obtain data regarding user weigh-in behavior without intervening actions. In contrast, the treatment computing device 268b outputs an intervention message 270b that is intended to positively affect (e.g., increase) user weigh-in behavior.

The timing, manner, and content for outputting these messages 270a-b can be determined by the computing devices 268a-b based, at least in part, on the respective control and treatment rules 256, 258, the behavior information for the associated users, and/or other external factors. For example, the experiment designer may have defined the control and treatment rules 256, 258 so that the messages 270a-b would be output at set times (e.g., at 9 am every day), in response to particular user actions/inactions (e.g., in response to associated users not filling a prescription medication when expected), and/or based on combinations of user and/or external events (e.g., in response to users visiting a doctor after not having filled a prescription medication when expected).

The computing device 268a-b can obtain information about the associated users' behavior and/or other factors that may influence the users' behavior through any of a variety of appropriate data sources. For example, the users 272a-b of the devices 268a-b can provide input 274a-b that is received/detected by the computing devices 268a-b. Such user input 274a-b can include direct input (e.g., typed input, speech input, touch-based input, gesture input, pushing physical buttons) and/or indirect input (e.g., user movement of the devices 268a-b, background speech observed by the devices 268a-b). For example, the user input 274a-b can include health behavior that is logged by the users 272a-b using the computing devices 268a-b.

In another example, the computing devices 268a-b can obtain user data 278a-b from one or more peripheral devices 276a-b that monitor, detect, and/or track user behavior, such as fitness trackers (e.g., FITBIT devices, bike computers, fitness machine computers), measuring devices (e.g., digital scales, blood pressure monitoring devices), and/or other peripheral devices that monitor, detect, or otherwise track user behavior. For example, the user data 278a-b can include data from a Wi-Fi scale that is connected to the computing devices 268a-b regarding user weigh-ins.

In a further example, the computing devices 268a-b can obtain user and other data 282a-b from one or more external computer system 280a-b, such as social network computer systems (e.g., FACEBOOK, fitness-based social network systems), search engines (e.g., GOOGLE), environmental computer systems (e.g., WEATHER.COM, NOAA), health information databases (e.g., a pharmacy benefits management database, medical claims data, electronic medical record data) and/or other computer systems that may track, monitor, receive, or otherwise have access to information regarding the users 272a-b and/or external factors that may affect the behavior of the users 272a-b. For example, the data 282a-b can include social networking activity for the user (e.g., social network posts by the user or friends of the user, comments, likes, shared content), searches performed by the user (e.g., searches submitted to search engines), weather information (e.g., temperature, forecast), prescription fills (e.g., date of prescription fill), disease diagnosis (e.g., date of hypertension diagnosis), medical treatment (e.g., heart surgery) and/or other appropriate information.

The users may provide permission/consent for the computing devices 268a-b and/or applications implementing the experiments on the computing devices 286a-b (e.g., mobile apps) to access and use data from the sources 272a-b, 276a-b, and/or 280a-b, and/or other data sources not included.

The computing devices 268a-b can determine user behavior and results for the experiment using this data. For example, the computing devices 268a-b can log information about the actions (e.g., interventions, control actions) that are performed by computing devices 268a-b as part of the experiment (e.g., timestamp for actions, type of actions, content output as part of actions), user behavior in response to the actions (e.g., weigh-ins using a digital scale, activity levels, diet), other user behavior information that may be incorporated into or otherwise used as part of the results (e.g., social networking activity, media consumption behavior, travel and transit patterns), medical information (e.g., DNA data, medical claims data, pharmacy benefits data) and/or environmental information and other external factors (e.g., weather, activity level of friends on social media, news events, disease outbreaks).

As indicated by steps Q and Q′ (284a-b), the computing devices 268a-b can provide the results 286a-b to the computer system 204. The results 286a-b can be provided periodically during the experiment (e.g., daily basis, weekly basis, monthly basis) and/or at the conclusion of the experiment. The results 286a-b may be provided as raw data (e.g., log of actions performed by the devices 268a-b and a log of weigh-ins by the user) and/or as aggregated data (e.g., weigh-in frequency over a period of time). The results 286a-b may additionally be provided with anonymous identifiers for the corresponding users, such as identifiers for the users that were generated by the computer system 204 for the experiment. In some implementations, the results 286a-b may additionally and/or alternatively be provided by the devices 268a-b to the experiment designer computing device 202, such as with the use of anonymous user information and aggregated result information.

The computer system 204 can store and aggregate the results for the experiment for the control arm and the treatment arm, as indicated by step R (288). For instance, the control results 286a and the treatment results 286b can be stored in the experiment data repository 260. The computer system 204 can aggregate the results from all of the computing devices that participated as part of the control arm 248 and the results from all of the computing devices that participated in the treatment arm 250. The computer system 204 can additionally determine statistical population distributions of the results for the two example arms (any number of arms can be used) as well as the mean values and standard deviations. The computer system 204 can compare this information for the control and treatment arms to determine whether a statistically significant result was detected as part of the experiment, which can involve determining the lift observed for the treatment arm and the p-value for that observation.

The computer system 204 can additionally generate anonymized result information, as indicated by step S (290). Such anonymized result information can include granular information about the participants in both the control and treatment arms 248, 250 that can be accessed and divided along a number of dimensions, such as metrics specifically requested as part of the experiment (e.g., weigh-in frequency, other health behavior metrics), demographic information (e.g., age, gender), medical information (e.g. diagnosis, drug prescriptions) and/or external factors observed for the participants with participant permission (e.g., location, weather, social network influence). The computer system 204 can use any of a variety of appropriate techniques to ensure that the results are sufficiently anonymous so that they could not be divided in such a way that the results for an individual could be determined, such as through k-anonymous techniques.

The computer system 204 can provide anonymized experiment results 294 to the experiment designer computing device 202, as indicated by step T (292). The results 294 can be provided on an on-going basis during the experiment and/or at the conclusion of the experiment. Results provided while the experiment is being conducted may allow for the experiment designer 202 to further modify and/or revise the experiment before its conclusion. For instance, if the experiment designer 202 receives results indicating that one of the treatment arms does not appear to improve weigh-in frequency over the control group, the experiment designer 202 may decide to drop that treatment arm from the experiment and to add a different treatment arm to the experiment. The computer system 204 can receive information about experiment modifications and can implement using the same or similar steps described above for designing experiments (FIG. 2A) and deploying experiments (FIG. 2B). By providing results midstream and allowing the experiment designer to modify the experiment on the fly, the computer system 204 can shorten the iterative process for the researcher to refine and test out techniques.

The experiment designer computing device 202 can output the results, as indicated by step U (296). For instance, the experiment designer computing device 202 can output the example user interface 298, which includes example results of the frequency for weigh-ins increasing 30% over the control group and that the results have a p-value of 0.0001.

FIGS. 3A-B are conceptual diagrams of an example system 300 using decentralized techniques for implementing an experiment. The example system 300 is similar to the system 200 described above with regard to FIGS. 2A-C, and includes a number of the same components, including the experiment designer computing device 202, the experiment computer system 204, the user computing devices 206, and the experiment data repository 260. FIGS. 3A-B depict an example technique to randomly assign users into different arms of an experiment and to report results for the experiment in a decentralized manner. These example decentralized techniques can be performed in addition and/or as an alternative to the centralized assignment and reporting techniques depicted in FIGS. 2B-C (e.g., a portion of an experiment can be assigned to different arms in a centralized manner and another portion of an experiment can be assigned to different arms in a decentralized manner).

Segmentation can refer to the capability of a system (e.g., system 204) to select and present slices of a population (segments or cohort) to experiment designers based on certain criteria (e.g., age and gender). An example of segment is “males 25 y/o or older”. Assignment refers to the procedure by which individual of the population are assigned to treatment or control arms for the experiment. Assignment can be performed at random in a centralized manner and/or a decentralized manner. Random assignments can be performed within a given segment. For instance, experiment designers (through a population segmentation module) can select the segment “males 25 y/o or older” to run an experiment on, and the system can split that segment in treatment/control through random assignment (either centralized or distributed).

Referring to FIG. 3A, the experiment designer computing device 202 can receive input, including example parameters 304, for an experiment, as indicated by step A (302). The input received at step A (302) is similar to the step I (240) described above with regard to FIG. 2B, and can be received by the experiment computing device 202 after designing the experiment as described with regard to FIG. 2A. Similar to step J (244), experiment designer computing device 202 can provide the experiment parameters 304 to the experiment computer system 204, as indicated by step B (306).

Instead of performing a centralized random assignment of the selected population (users/user devices determined to satisfy the inclusion/exclusion criteria for the experiment) into the control and treatment arms, as described above with regard to FIG. 2B, the experiment computer system 204 in this example can use decentralized techniques to randomly assign the selected population into the arms for the experiment. As indicated by step C (308), the computer system 204 can determine decentralized assignment information that can be used by the user computing devices 206 to guide their self-allocation to one of the arms of the experiment (or to not being included in the experiment). The random self-assigned is performed by the device by means of a random number generator internal to the device. The assignment information can include information, such as assignment probabilities and/or weights, that can be used by the computing devices 206 assign themselves to appropriate arms of the experiment.

For instance, using the example experiment parameters 304 (sample size of 4,000 participants for experiment, 1 control arm, 1 treatment arm), assuming that 5,000 users satisfy the inclusion/exclusion criteria, and assuming the arms for the experiment are chosen to be equal size, computer system 204 can determine that the probability of a device to assign itself to the control arm is 40% (2,000 participants/5,000 users), the probability of a device of assigning itself to the treatment arm to 40% (2,000 participants/5,000 users), and that the probability of not being included in the experiment is 20% (1,000 participants/5,000 users). These probabilities can be determined as the assignment information by the computer system 204. The probabilities for the arms of the experiment can differ from each other.

The computer system 204 can initiate the experiment, as indicated by step D (310), and can store information about the experiment in the experiment data repository 260, as indicated by step E (312). The computer system 204 can initiate the experiment by providing experiment information to each of the user computing devices 206 associated with the users who have been determined to satisfy the inclusion/exclusion criteria for the experiment. This group of computing devices 206 can be greater than the sample size for the experiment that was designated by the experiment designer computing device 202. The experiment information can include assignment information 316 (in case the assignment has been defined in a centralized manner), control rules 318 for the control arm of the experiment, and treatment rules 320 for the treatment arm of the experiment. Since each of the user computing devices 206 can potentially be assigned to any of the arms of the experiment, the rules for each of the arms of the experiment can be provided to each of the user computing devices 206.

Using the assignment information 316, each of the user computing devices 206 can determine an arm assignment for the experiment, as indicated by step G (322). The user computing devices 206 can use any of a variety of appropriate techniques to do this. For instance, the computing devices 206 can determine experiment arm assignments based on weightings for the arms determined from the assignment information (e.g., probabilities) and randomly generated values. For example, the computing devices 206 can each generate a random number between 0 and 4, and can associate ranges of the random number to different arms of the experiment based on the assignment probabilities. For example, the control arm can be associated with 0 and 1 (40% of the value range), the treatment arm can be associated with 2 and 3 (40% of the value range), and no arm of the experiment can be associated with 4 (20% of the value range). Depending on the value of the random number that is generated, each of the computing devices 206 can self-assign into either the control arm, the treatment arm, or to not participating in the experiment (no arm of the experiment). For instance, as depicted in the example, a portion of the user devices 206 self-assign into the control arm 248 and a portion of the user devices 206 self-assign into the treatment arm 250.

In some implementations, the user devices 206 can keep their self-assignments into the arms 248, 250 of the experiment private and may not report such details to the computer system 204.

In other implementations, the user devices 206 can report information identifying their self-assignments to the computer system 204, such as anonymous information for the user devices 206. In such instances, the computer system 204 may attempt to correct any deficiencies in the distribution of users across the arms of the experiment, such as through centralized assignment/modification of the groups using the techniques described above with regard to FIG. 2B.

Referring to FIG. 3B, the experiment can be implemented on the control arm 248 and treatment arm 250 in the same way as described above with regard to FIG. 2C. For example, the user computing devices 268a-b can perform the experiment using the appropriate rules for the corresponding arm of the experiment, as indicated by steps H and H′ (324a-b), and obtain user behavior information from the data sources 272a-b, 276a-b, and/or 280a-b, as indicated by steps I and I′ (326a-b).

In the depicted example, the computing devices 286a-b can additionally provide results for the experiment in a decentralized manner. To do this while ensuring user privacy, the computing devices 286a-b can aggregate and/or anonymize results that are obtained by the computing devices 286a-b as part of the experiment, as indicated by steps J and J′ (328a-b). Aggregation can include combining raw data information (e.g., weigh-in logs) to generate data (e.g., average daily weigh-in frequency over the duration of the experiment period) that will shield granular behavior information about the users from being provided to the computing device 202. Anonymizing the results can be done through any of a variety of appropriate techniques to shield the identity of the users and/or user computing devices 268a-b from being relayed to the computing device 202, such as removing identifiers for users and the computing devices 268a-b from transmissions to the computing device 202, using differential privacy techniques, using proxies to mask the source of traffic from the computing devices 268a-b, and/or other appropriate techniques.

With the results aggregated and anonymized, the computing devices 268a-b can provide the control results 286a and the treatment results 286b to the experiment designer computing device 202, as indicated by steps L and L′ (330a-b). These decentralized results can be provided to the experiment designer computing device 202 at various points during the experiment and/or at the conclusion of the experiment. When reporting mid-stream results to the experiment designer computing device 202, the user computing devices 268a-b may check to determine whether enough data has been collected so that it can be sufficiently aggregated so as to shield granular inferences into the users' behavior by the experiment designer.

The experiment designer computing device 202 can combine the individual results 286a-b from the computing devices 268a-b, determine aggregate outcomes for the experiment (e.g., treatment lift over control, p-value), and can output the results, as indicated by step M (332). The outcome of the experiment can be provided in any of a variety of ways, such as in the example user interface 298.

In some instances, the experiment designer computing device 202 can additionally provide results for the experiment to the computer system 204, as indicated by step N (334), which the computer system 204 can store in the experiment data repository 260, as indicated by step 0 (336).

The FIGS. 2A-C and 3A-B depict example techniques for designing experiments, deploying experiments, and obtaining results for experiments. These example techniques can be used interchangeably and/or in combination with each other, in whole or in part. For example, the experiment designing techniques described above with regard to FIG. 2A could be used in combination with the distributed deployment of the experiment described in FIG. 3A and with the centralized reporting techniques described with regard to FIG. 2C. In another example, the experiment designing techniques of FIG. 2A can be used the centralized deployment techniques of FIG. 2B and the decentralized deployment techniques of FIG. 3A (e.g., a portion of the participants can be selected in a centralized manner and a portion of the participants can be selected in a decentralized manner).

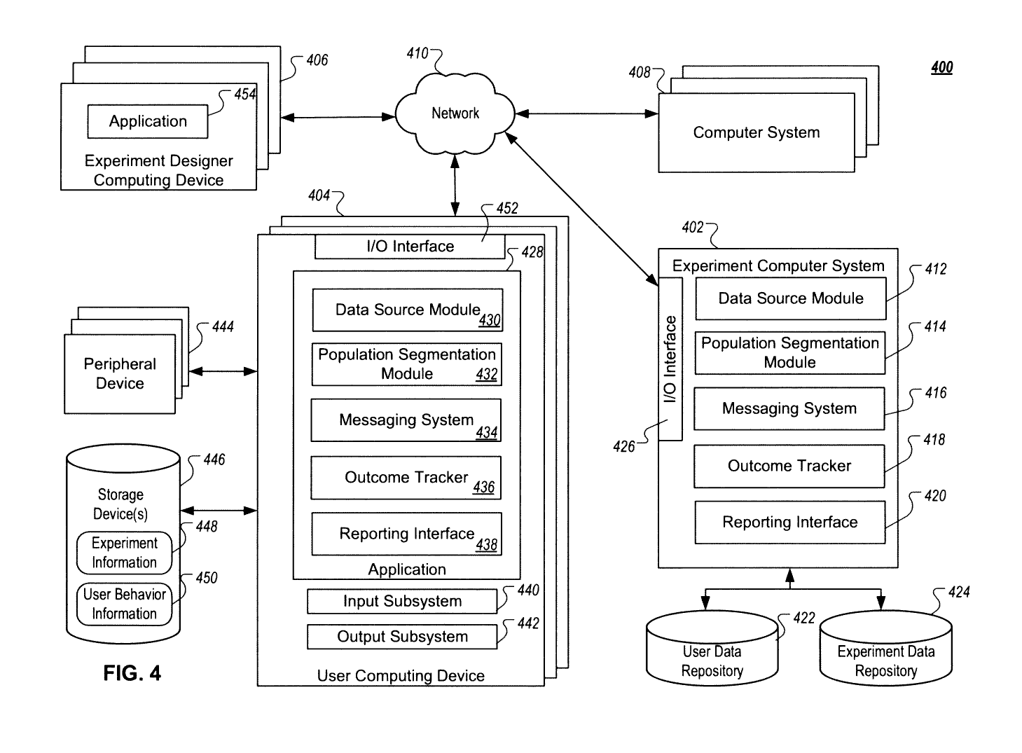

FIG. 4 depicts an example system 400 for providing an experimentation platform. The system 400 includes an experiment computer system 402, user computing devices 404, experiment designer computing devices 406, other computer systems 408, and one or more communication networks 410.

The experiment platform provided by the system 400 can simplify designing experiments, such as clinical trials, that test the impact of various actions on user behavior, such as interventions are the most effective at inducing behavior change and habit formation in a population. For example, the system 400 can be used to test interventions related to habits such as physical activity (e.g., walking, running, workout), medical management adherence (e.g., adhering to medication, measuring blood pressure, measuring glucose levels), journaling (e.g., food logging, mood reporting), and/or engagement with a wellness-tracking platform (e.g., app or website usage). The experiment platform can be used in a variety of different contexts, such as physical and mental health/wellness, financial management, and/or other appropriate contexts.

The experiment computer system 402 can be any of a variety of appropriate computer systems (e.g., server system, cloud-based computer system, collection of one or more computing devices) and can be similar to the experiment computer systems 104 and 204. The computer system 402 is depicted as including a data source module 412, a population segmentation module 414, a messaging system 416, an outcome tracker 418, and a reporting interface 420.

The data source module 412 can be programmed to gather behavioral data from a subject population. Users can grant the data source module 412 with granular access to on any of data sources, such as the computer systems 408 and/or data collected by the user computing devices 404, on a variety of bases, such as a per-experiment and/or a per-data source basis. For example, the data source module 412 can be provided with access to users' activities on social networks (e.g., FACEBOOK, TWITTER) and/or movement data captured by peripheral devices like sensors and pedometers (e.g., FITBIT, JAWBONE).

The population segmentation module 414 may be interactive and collaborative and allows third party entities (e.g., experiment designers) to contribute in selecting the tested cohorts. The population segmentation module 414 can, for example, identify different cohorts to target through the use of inclusion/exclusion criteria set forth by the experiment designer. For example, the population segmentation module 414 can exclude users who are already part of another experiment.

The population segmentation module 414 can also compute the minimum population size required to detect an effect of the desired magnitude or larger with the desired statistical power and significance. The population segmentation module 414 can also assign the tested population to various arms of the experiment. In some implementations, the module 414 can allow a third party, such as the experiment designer computing devices 406, to assign users to arms of the experiment while only disclosing non-personally identifiable information.

To allow even tighter control of information privacy, the population segmentation module 414 can automatically examines the cohort rules that the third party experiment designer 406 has provided. If any of the rules cut the population into cohorts of size less than K, then it can be determined to constitute a privacy violation and the population segmentation module 414 system will not allow it. The risk of small groups can be that the third party may be given access to aggregate information about the group, such as average age, average weight, count of heart attacks, and if the group is too small, the third party may be able to work backward from the definition of the cohort to the identities of individual using public records and therefore learn private information about those individuals. The population segmentation module 414 can safeguard against this by flexibly and proactively prevent these privacy violations in response to the level of protection (the K value) that is used in each case.

The messaging system 416 can designate and deploy behavior-changing interventions to the different treatment arms through different messaging channels (e.g., text messaging, push notifications, voice messages, emails). The messaging system 416 can also select different delivery time schedules for those interventions, which can be optimized individually by subject and/or activity. Additionally, the messaging system 416 can alert caregivers, coaches and/or others responsible for the subject's care.

Per-subject delivery time optimization can include various techniques. For example, time optimizations can be based on the subject's history of when they've performed the desired activity in the past, and can infer that those will be good times to encourage the activity in the future. In another example, time optimizations can be computed using a similarity metric between each pair of subjects based on how similar their behavior patterns and demographic information are. For instance, two subjects who go for runs on the weekends can be determined to have a high similarity, whereas a weekend runner and a weeknight runner can be determined to have low similarity. As experiments proceed, the messaging system 416 can keep track of which delivery times have worked well for which subjects, and which have not. Collaborative filtering techniques can be used to estimate, for a particular subject, which intervention times are optimal, and these estimates can be based on inferences that combine how effective interventions were for the subject's most similar peers with how similar those peers are to the subject.

The outcome tracker 418 can measure targeted subjects' activities in response to the intervention performed during and/or after the experiment. In particular, the outcome tracker 418 can track every subject interaction with the delivered messages and optionally feedback the outcome results to the population segmentation system so arms can be dynamically updated (e.g., using multi-armed bandit strategies).

The reporting interface 420 can visualize the experiment parameters and outcomes, such as reporting the lift of the treatment arms with respect to the control arm and visualizing statistical significance of the lift in treatment arms vs. the control arm.

The experiment computer system 402 can allow for various aspects of the experimentation platform to be centralized and/or decentralized, which can have various privacy implications. In an example privacy-preserving incarnation, the computer system 402 can implement the platform to be fully-distributed and entirely offloaded to the user computing devices 404, which can allow all user data to remain on the devices 404. For instance, in such a privacy-preserving case, the on-device data source component can feed data to a population segmentation system (which can also be on the devices 404), which contains preloaded parameters that define segments (externally computed and/or sourced, and potentially updated over time). Based on the input data produced by the user and recorded by their devices 404, which in this example doesn't leave the devices 404, users are placed in different segments and within the segment can be assigned to a treatment or control arm. This can allow the population to be partitioned into different arms in a decentralized and distributed way. The assignment to a treatment or control arm can be done at random and/or externally defined through rules that are only evaluated on the device (e.g., assign user to the control arm if and only if their phone IMEI is an even number).

In a decentralized implementation, appropriate messaging can be performed by messaging systems on the devices 404 based, for example, on rules (externally defined and/or sourced, and potentially updated over time). An onboard outcome tracker system on the devices 404 can also allow for results to be determined without any data leaving the devices. Results (e.g., time-aggregate, de-identified data on the outcome of the intervention and on the duration of the habit formation) may be communicated to entities outside the devices 404.

The experiment computer system 402 can additionally include an input/output (I/O) interface that is configured to communicate with the computing devices/systems 404-408 using the network 410. The computer system 402 can also access data repositories that can be local and/or remote from the system 402, such as an example user data repository 422 storing information about users who are candidate to participate in experiments and an experiment data repository 424 storing experiment information and results.

The user computing devices 404 can be similar to the computing devices 206 and 268a-b. The user computing devices 404 can include an application 428 (e.g., mobile app, web application) that is installed on the computing devices 404 and is configured to perform operations on the computing devices 404 to implement the experimentation platform. The application 428 can include one or more components 430-438 that are similar to and/or communicate with the components 412-420 of the experiment computer system 402. For example, the application 428 is programmed to include a data source module 430 that can collect data on the computing devices 404 (e.g., user input, data from peripheral devices); a population segmentation module 432 that is programmed to perform decentralized operations regarding determining whether users satisfy inclusion/exclusion criteria for an experiment and/or assigning users to arms of an experiment; a messaging system 434 that is programmed to determine when and how to implement interventions on the devices 404; an outcome tracker 436 that is programmed to track outcomes based on interventions that are performed on the devices; and a reporting interface 438 that is configured to report results, including anonymous and/or de-identified results.

The user computing devices 404 also include an input subsystem 440 (e.g., touchscreen, microphone, sensors, physical keys/buttons) through which users can provide input to the devices 404 that are used by the application 428. The computing devices 404 also include an output subsystem 442 (e.g., display, speakers, haptic devices) through which the application 428 can provide output that can be sensed by the users of the devices 404.

The user computing devices 404 can be in communication with one or more peripheral devices 444 that can include various sensors and/or components to monitor and obtain information about users. For example, the peripheral devices 444 can be activity trackers, such as pedometers, heart rate monitors, and/or location trackers, that log activity information. The peripheral devices 444 can provide the logged activity information to the computing devices 404 through one or more wired and/or wireless data connections (e.g., USB, BLUETOOTH).

The user computing devices 404 additionally access one or more storage devices 446 (e.g., internal storage device, external storage device, network storage device, cloud-based storage device) that can store experiment information 448, such as rules to implement an arm of an experiment, and user behavior information 450 that can indicate how users respond to various interventions performed by the devices 404. The user computing devices 404 can further include I/O interfaces 452 through which the computing devices 404 can communicate with the other computing devices/systems through the network 410.

The experiment designer computing devices 406 can be similar to the experiment designer computing devices 102 and 202. The experiment designer computing devices 406 can, through the use of applications 454 (e.g., mobile app, web application), design experiments through interactions with the experiment computer system 402 and process/view results for the experiments.

The other computer systems 408 can be similar to the computer system 280a-b. The other computer systems 408 (e.g., social network systems, fitness-related systems, search engines) may store and/or track information about the users of the computing devices 404 that, with the users' consent/permission, can be provided to and made accessible to the data source modules 412 and/or 430 of the experiment computer system 402 and/or the user devices 404.

The network 410 can be any of a variety of appropriate communications networks, such as the internet, wireless networks (e.g., Wi-Fi, wireless data networks, BLUETOOTH networks), LANs, WANs, VPNs, and/or any combination thereof.

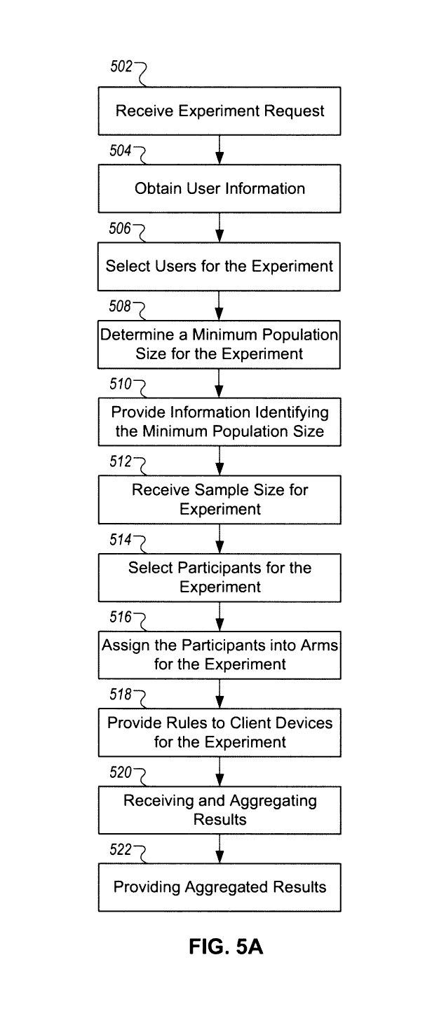

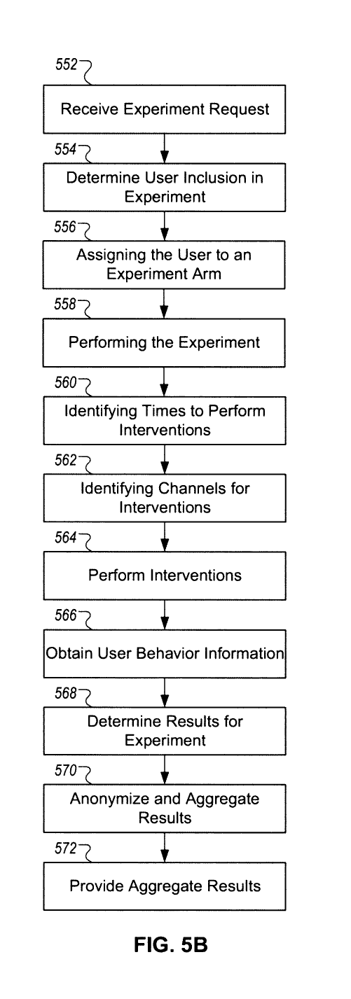

FIGS. 5A-B are flowcharts of example techniques 500 and 550 for implementing aspects of an example experimentation platform. The example technique 500 can be performed by any of a variety of appropriate computer systems, such as the experiment computer systems 104, 204, and/or 402. The example technique 550 can be performed by any of a variety of appropriate computing devices, such as the user computing devices 206, 268a-b, and/or 404.

Referring to FIG. 5A, the example technique 500 can begin with the receiving an experiment request (502). For example, the computer system 402 can receive a request to design an experiment from one or more of the experiment designer computing devices 406. User information can be obtained, such as information indicating whether users satisfy criteria to participate in the experiment (504). For example, the computer system 402 can access user information from the user data repository 422 and/or can obtain indications from the user computing devices 404 as to whether corresponding users satisfy the criteria. Based on the obtained user information, users can be selected for the experiment (506). For example, users who satisfy the criteria for the experiment can be selected as the candidate population for deploying the experiment.

Using the selected population and other parameters for the experiment provided by the experiment designer, a determination can be made as to the minimum population size that can be used for the experiment (508). For example, given the selected population and its distribution across one or more metrics, the population segmentation module 414 can determine a minimum population that would provide the desired results for the experiment (e.g., deviation from existing mean, minimum statistical power for detecting an effect) and that would ensure user privacy is maintained throughout the experiment (e.g., ensure k-anonymous results). Information identifying the minimum population size can be provided, for example, to the experiment designer computing device (510).

After providing the minimum population size information, a sample size designated by the experiment designer can be received (512). Based on the sample size, a portion of the population for the experiment can be selected to participate in the experiment (514) and can be randomly assigned to one arm for the experiment (516). For example, the population segmentation module 414 can assign the population into arms for the experiment using centralized and/or decentralized techniques. Rules for the arms of the experiment can be provided to client devices for the experiment (518). For example, the population segmentation module 414 can generate rules for each of the arms of the experiment and can provide those rules to corresponding client computing devices 404.

Results for the experiment can be received and aggregated (520). For example, the outcome tracker 418 can receive results from the client computing devices 404 participating in the experiment and can aggregate the results, which can provide a layer of privacy protection for users. The aggregated results can be provided (522). For example, the reporting interface 420 can transmit the results to the experiment designer computing device 406.

Referring to FIG. 5B, an experiment request can be received (552). For example, the user computing devices 404 can receive information regarding an experiment, such as inclusion/exclusion parameters for the experiment. A determination can be made as to whether a corresponding user satisfies the criteria for inclusion in the experiment (554). For example, the population segmentation module 432 can determine whether a user satisfies inclusion/exclusion criteria for the experiment. If a user qualifies, the user can be assigned to an arm of the experiment (556). For example, the population segmentation module 432 can assign users of the computing devices 404 (and/or the devices 404) to appropriate arms of the experiment based, for example, on assignment information received with the request (e.g., control and treatment arm assignment probabilities).

The experiment can be performed (558), which can include identifying times to perform interventions (560), identifying channels for the interventions (562), and performing the interventions (564). Interventions can include outputting messages via one or more messaging channels to the user. For example, the messaging system 434 can determine when and how to intervene with users of the computing devices 404 based on rules for corresponding arms of the experiment.

User behavior for the interventions can be obtained (566). For example, the outcome tracker 436 can track how users behave and respond to interventions that are performed by the computing devices 404. Results can be determined for the experiment based on the obtained user behavior information (568), and these results can be anonymized and aggregated (570). For example, the reporting interface 438 can aggregate and anonymize results that are obtained by the outcome tracker 436. The results can be provided (572). For example, the reporting interface 438 can provide the results to the experiment computer system 402 and/or to the experiment designer computing device 406.

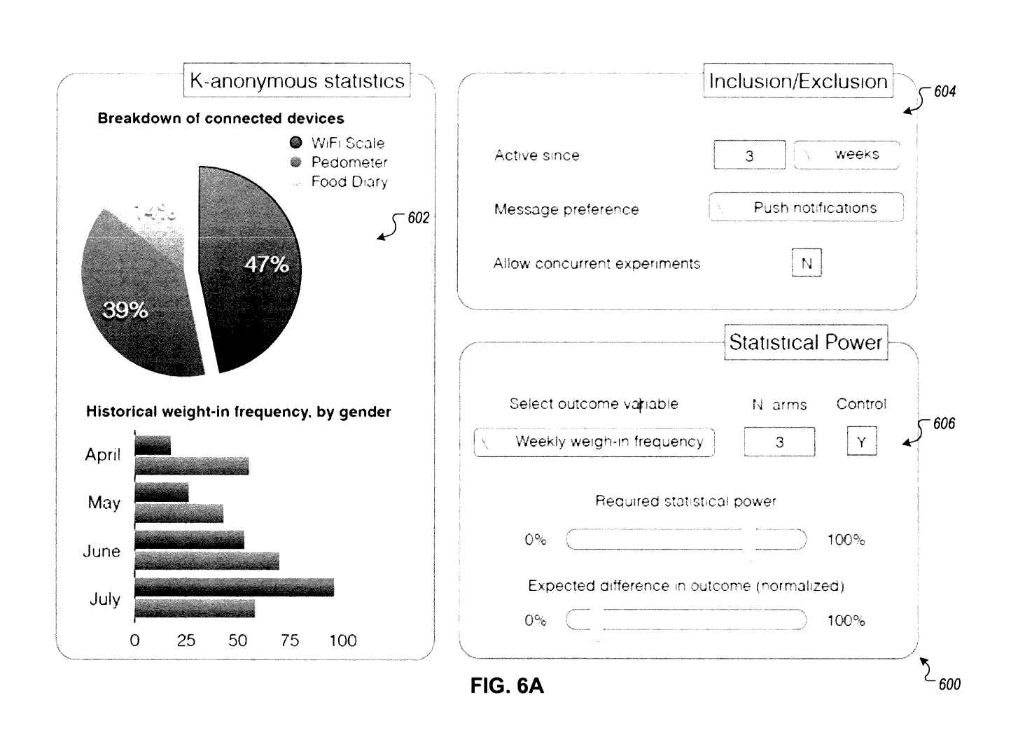

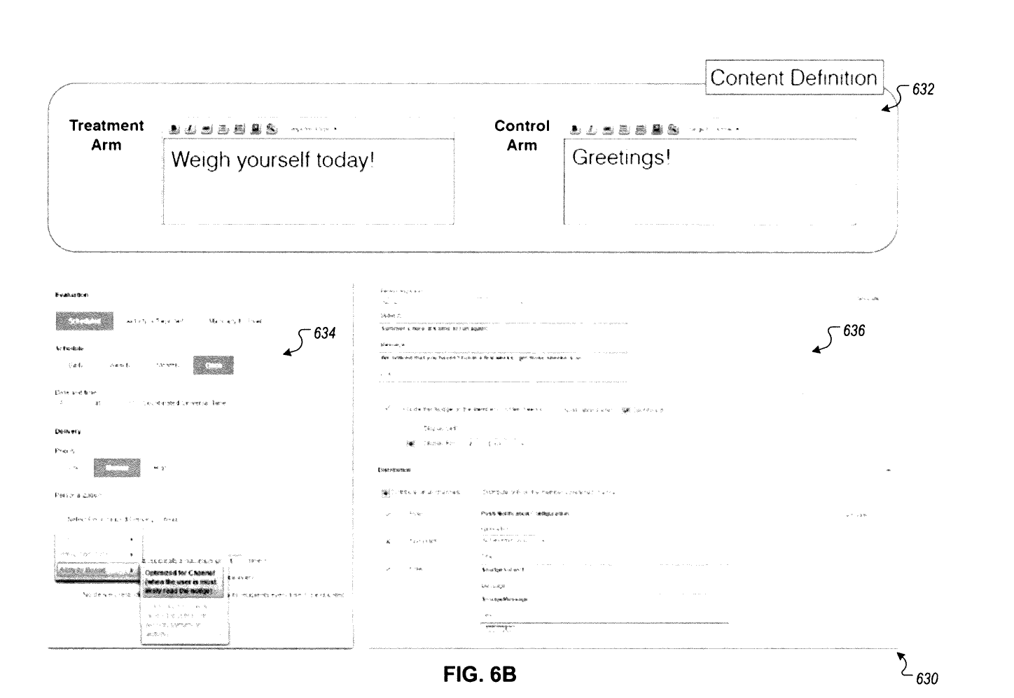

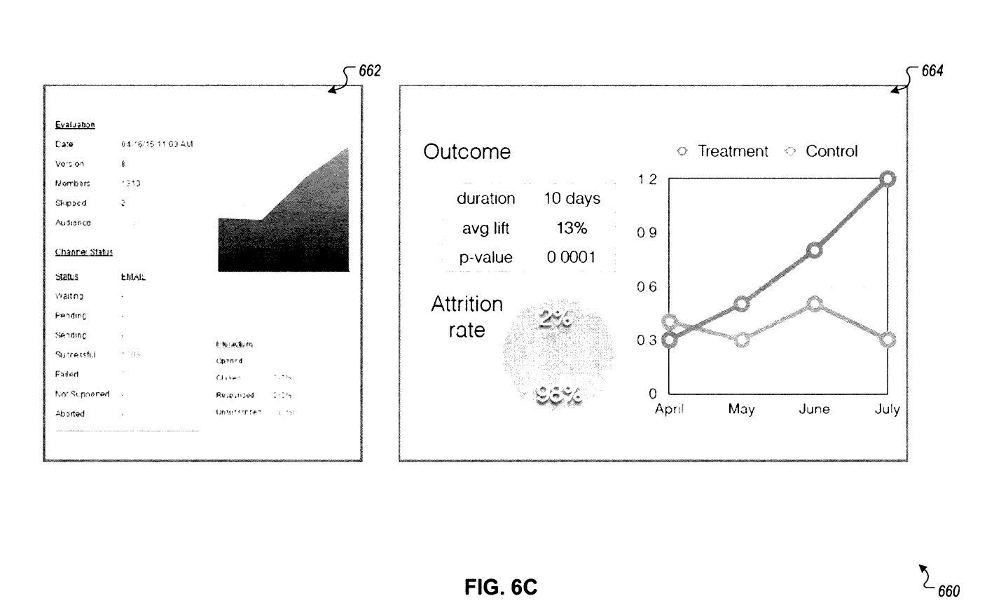

FIGS. 6A-C are screenshots of example user interfaces that can be used as part an experimentation platform.

Referring to FIG. 6A, an example user interface 600 is depicted for designing an experiment. The example user interface 600 can be output, for example, by a computing device being used by an experiment designer, such as the experiment designer computing devices 102, 202, and/or 406. The user interface 600 includes a first portion 602 that includes anonymous statistics about the population of users who may participate in the experiment, a second portion 604 through which inclusion/exclusion criteria can be defined for the experiment, and a third portion 606 in which outcome parameters for the experiment can be defined.

Referring to FIG. 6B, an example user interface 630 is depicted for designing interventions to be performed as part of the experiment. The example user interface 630 can be output, for example, by a computing device being used by an experiment designer, such as the experiment designer computing devices 102, 202, and/or 406. The user interface 630 includes a first portion 632 that includes fields in which the content for messages (example interventions) for different arms of the experiment can be defined, a second portion 634 in which rules for delivering the messages can be defined, and a third portion 636 in which additional rules for delivering the messages can be defined.

Referring to FIG. 6C, an example user interface 660 is depicted for viewing results for the experiment. The example user interface 660 can be output, for example, by a computing device being used by an experiment designer, such as the experiment designer computing devices 102, 202, and/or 406. The user interface 660 includes a first portion 662 that includes status information for the experiment while it is in process and a second portion 664 that depicts outcomes for an example experiment using a control arm and a treatment arm.

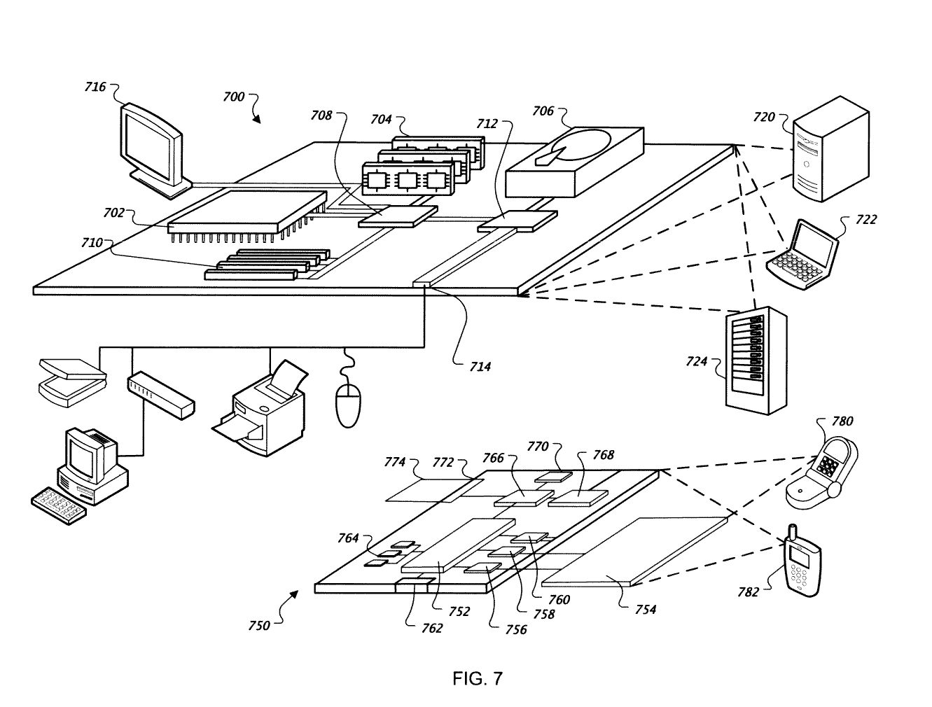

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. Additionally computing device 700 or 750 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method, comprising:
receiving, at a computer system and from an experiment designer computing device, a request to perform an experiment across a plurality of client computing devices that are associated with a plurality of users, wherein the request includes (i) criteria for users to be included in the experiment and (ii) parameters for the experiment;
obtaining, by the computer system, information for the plurality of users that indicates whether the plurality of users satisfy the criteria for the experiment;
selecting, by the computer system, a subset of the plurality of users for the experiment based, at least in part, on the information;
determining, by the computer system, a minimum population size to provide at least a threshold (i) level of anonymity for participants in the experiment and (ii) power calculation for results of the experiment, wherein the minimum population size is determined based, at least in part, on the subset of the plurality of users and the parameters for the experiment; and
providing, by the computer system and to the experiment designer computing device, information that identifies the minimum population size for the experiment.

2. The computer-implemented method of claim 1, wherein obtaining the information for the plurality of users comprises:
providing, by the computer system, the criteria to the plurality of client computing devices, wherein the plurality of client computing devices are each programmed to evaluate the criteria locally and to determine whether a user that corresponds to a particular client device satisfies the criteria for the experiment; and
receiving, at the computer system, responses from the plurality of client computing devices that indicate whether their corresponding users satisfy the criteria, wherein the information for the plurality of users comprises the responses from the plurality of client computing devices.

3. The computer-implemented method of claim 2, wherein the responses from the plurality of client computing devices are received without receiving underlying data that describes aspects of a user that the client computing devices uses to evaluate the criteria for the experiment.

4. The computer-implemented method of claim 1, wherein obtaining the information for the plurality of users comprises:
accessing, by the computer system, current data for the plurality of users and for the plurality of client computing devices from one or more data sources; and
determining, by the computer system, whether the plurality of users satisfy the criteria based on a comparison of the data with the criteria.

5. The computer-implemented method of claim 1, wherein the criteria includes one or more of the following: access to health monitoring devices, current use of the health monitoring devices, current health behavior, current or past communication and social behavior, one or more current medical conditions, a current health context, message and notifications settings on the plurality of client computing devices, and current involvement in other experiments.

6. The computer-implemented method of claim 1, wherein the subset of the plurality of users that are selected comprises users who are determined to satisfy the criteria for the experiment.

7. The computer-implemented method of claim 1, wherein the parameters for the experiment include one or more of the following: a desired statistical power to detect an effect of a particular size, a number of arms to be used for the experiment, and a hypothesis to be tested with the experiment.

8. The computer-implemented method of claim 7, wherein the hypothesis to be tested includes one or more of: a threshold change in health behavior along one or more dimensions for users within a treatment arm for the experiment and a threshold change in one or more medical conditions along one or more dimensions for users within the treatment arm for the experiment.

9. The computer-implemented method of claim 1, wherein the threshold level of anonymity comprises k-anonymity for users included the experiment based on the parameters for the experiment and a number of data fields across which results for the experiment will be provided to the experiment designer computing device.

10. The computer-implemented method of claim 1, further comprising:
determining, by the computer system, whether the subset of the plurality of users satisfies the minimum population size; and
determining, in response to determining that the subset of the plurality of users is less than the minimum population size, that the experiment is unable to be performed as designed,
wherein the information that is provided to the experiment designer computing device additionally indicates that the experiment is unable to be performed as designed.

11. The computer-implemented method of claim 1, further comprising:
receiving, at the computer system and after providing the minimum population size, information that designates a sample size for the experiment;
selecting, by the computer system and based on the sample size, participants for the experiment from among the subset of the plurality of users, wherein the participants are associated with a subset of the client computing devices; and
providing, by the computer system and to the subset of the client computing devices, one or more sets of rules to be followed by the subset of the client computing devices to implement the experiment.

12. The computer-implemented method of claim 11, further comprising:
assigning, by the computer system, the participants into a plurality of arms for the experiment, wherein each of the plurality of arms uses a different one of the sets of rules to implement the experiment.

13. The computer-implemented method of claim 11, further comprising:
receiving, at the computer system and from the subset of client computing devices, results from the experiment;
aggregating, by the computer system, the results so that information about the participants is anonymous; and
providing, to the experiment designer computing device, the aggregated results.

14. A computer-implemented method comprising:
receiving, at a computer system, parameters for an experiment to be performed across a plurality of client computing devices that are associated with a plurality of users, wherein the parameters identify a plurality of arms for the experiment that will each be exposed to different stimuli as part of the experiment;
determining, by the computer system and based on the parameters, a plurality of rule sets to be used by the plurality of client computing devices to implement the plurality of arms of the experiment;
generating, by the computer system, assignment information to be used by the plurality of client computing devices to randomly assign themselves into the plurality of arms;
providing, by the computer system and to each of the plurality of client computing devices, the plurality of rule sets and the assignment information, wherein each of the client computing devices is programmed to assign itself, based on the assignment information, to one of the plurality of arms and to implement the experiment using one of the plurality of rule sets that corresponds to the one of the plurality of arms;
receiving, by the computer system, individual results for the experiment from the plurality of client computing devices; and
determining, by the computer system, aggregate results for each of the plurality of arms of the experiment based on aggregations of the individual results.

15. The computer-implemented method of claim 14, further comprising:
determining, by the computer system, assignment probabilities for the arms of the experiment, wherein each of the assignment probabilities indicates a likelihood that client computing devices will be assign themselves to a particular arm of the experiment;
wherein the assignment information comprises the assignment probabilities.

16. A computer-implemented method comprising:
receiving, at a client computing device and from a computer system, a request to participate in an experiment, wherein the request includes assignment information and rules for implementing the experiment on the client computing device;
assigning, by the client computing device, the user to one of a plurality of arms for the experiment based, at least in part, on the assignment information;
performing, by the client computing device, the one of the plurality of arms of the experiment on the client computing device based, at least in part, on the rules;
determining, by the client computing device, results for the experiment based, at least in part, on user behavior detected by the client computing device; and
providing, by the client computing device and to the computer system, the results.

17. The computer-implemented method of claim 16, wherein the request further includes inclusion information for the experiment on the client computing device
the method further comprising:
determining, by the client computing device, whether a user associated with the client computing device qualifies the participate in the experiment based, at least in part on the inclusion information,
wherein the assigning is performed in response to determining that the user qualifies to participate in the experiment.

18. The computer-implemented method of claim 16, wherein the assignment information includes probabilities for each of the plurality of arms of the experiment.

19. The computer-implemented method of claim 16, wherein performing the one of the plurality of arms of the experiment comprises:
identifying, based on the rules, one or more times to output a message on the client computing device;
determining, based on the rules, one or more messaging channels to use for outputting the message on the client computing device; and
outputting, by the client computing device, the message on the client computing device at the one or more times and using the one or more messaging channels.

20. The computer-implemented method of claim 16, wherein the user behavior is detected using one or more peripheral devices that monitor the user's physical activity and that are in communication with the client computing device.
